(19) United States
(12) Patent Application Publication
(10) Pub. No.: US 2026/0181478 A1
(43) Pub. Date: Jun. 25, 2026

(54) MULTIPLE PACKET FILTER OPERATIONS IN TFT

(71) Applicant: Telefonaktiebolaget LM Ericsson (PUBL), Stockholm (SE)

(72) Inventors: Jonathan STRÖM, Gothenburg (SE); Hong ZHANG, Göteborg (SE); Yumei SONG, Göteborg (SE); Ivo SEDLACEK, Hovorcovice (CZ); Mikael WASS, Sätila (SE)

(21) Appl. No.: 19/124,991

(22) PCT Filed: Oct. 31, 2023
(86) PCT No.: PCT/EP2023/080385

§ 371 Date: Apr. 28, 2025

Related U.S. Application Data
(60) Provisional application No. 63/381,808, filed on Nov. 1, 2022.

(51) Int. Cl. H04W 28/06; H04L 47/24; H04L 69/04; H04W 28/02; H04W 76/11

(52) U.S. Cl. CPC H04W 28/06; H04L 47/24; H04L 69/04; H04W 28/0263; H04W 76/11

(57) ABSTRACT

A method (700) performed by a wireless device (1000), a method (800) performed by a network node (908), wireless device apparatus (1000) and network node apparatus (908) for updating packet filters. In one example a method (700) is performed by a wireless device (1000) for updating packet filters when interworking between Evolved Packet System, EPS, and Fifth Generation System, 5GS, networks is configured. The method (700) comprising receiving (710) a message to modify a packet data unit, PDU, session, the message comprising more than one packet filters to be updated wherein each of the more than one packet filters is associated with a same EPS bearer identity and the message indicates that the wireless device perform more than one of the following operations: create new traffic flow template, TFT; delete existing TFT; add packet filters to existing TFT; replace packet filters in existing TFT; and delete packet filters from existing TFT. The method (700) then includes the wireless device (1000) performing (720) the updates for the identified EPS bearer and for the more than one packet filters.

### TECHNICAL FIELD

Embodiments herein relate generally to a network node and a method in the network node, and to a User Equipment (UE) and a method in the user equipment. More particularly the embodiments herein relate to radio communications, and in particular, to traffic flow templates (TFTs) for packet filter operations.

### BACKGROUND

Third Generation Partnership Project (3GPP) defines standards for policy and charging control (PCC). When a PCC rule is installed for a user session, one or more packet filters are installed according to the flow description(s) specified inside the PCC rule. There is a 1-to-1 relationship between flow descriptions and the number of packet filters, e.g., if 3 flow descriptions are specified in the PCC rule, then 3 packet filters are generated.

In fifth generation (5G) networks, the packet filters are encoded inside a quality of service (QoS) rule. Each QoS rule is associated with a QoS flow via its QoS flow identifier (QFI) and supports several operation codes that are specified in 3GPP technical specification (TS) 24.501 V18.0.0 subclause 9.11.4.13. The operation codes specify how the QoS rule and its contents are to be manipulated. The currently supported operations codes are:
Create new QoS flow
Delete existing QoS rule
Modify existing QoS rule and add packet filters
Modify existing QoS rule and replace all packet filters
Modify existing QoS rule and delete packet filters
Modify existing QoS rule without modifying packet filter

If interworking (IWK) between 5G and fourth generation (4G) is supported, packet filters used in the Evolved Packet System (EPS) are also encoded inside a mapped EPS bearer context if the user equipment (UE) is currently operating in 5G mode. If the UE is operating in 4G mode, QoS rule(s) will be encoded inside an EPS bearer context within the Protocol Configuration Option (PCO) information element (IE). It does not matter if the session is in 5G or 4G mode, packet filters for EPS and packet filters for 5GS are both present in QoS rule(s) and (mapped) EPS bearer contexts, if interworking of 5GS with EPS is supported.

Each EPS bearer context is identified by its EPS bearer identifier (EBI) and supports a few operation codes specified in 3GPP TS 24.501 V18.0.0 subclause 9.11.4.8 that specify a particular operation of the EPS bearer. These operations are:
Create new EPS bearer
Delete existing EPS bearer
Modify existing EPS bearer

The packet filters are encoded inside a traffic flow template (TFT) that resides inside the mapped EPS bearer context. TS 24.008 V18.0.0 subclause 10.5.6.12 defines TFT. Each TFT supports its own set of operation codes, used to manipulate the packet filters:
Ignore this IE
Create new TFT
Delete existing TFT
Add packet filters to existing TFT
Replace packet filters in existing TFT
Delete packet filters from existing TFT
No TFT operations

Each packet filter has an identifier that is unique within a particular TFT or QoS rule. The identifiers are used when deleting a specific packet filter, or in the case of TFT, replacing a particular packet filter. It is not possible to replace all filters inside a TFT, as it only supports the “Replace packet filters in existing TFT” operation which is used to replace one or more of the packet filters, as stated in 3GPP TS 24.008 V18.0.0 subclause 6.1.3.3.4.

For example, the syntactical errors in TFT operations are specified as follows: (a) when the TFT operation is an operation other than “Delete existing TFT” or “No TFT operation” and the packet filter list in the TFT IE is empty; (b) when the TFT operation is “Delete existing TFT” or “No TFT operation” with a non-empty packet filter list in the TFT IE; and/or (c) when the TFT operation is “Replace packet filters in existing TFT” and the packet filter to be replaced does not exist in the original TFT. This implies that the TFT operation of “Replace packet filters in existing TFT” is to replace one or more existing packet filters in an existing TFT, which is different than “replace all”.

There currently exist certain challenges. For example, how to add, delete and/or modify multiple packet filter operations.

### SUMMARY

Embodiments disclosed herein aim to address one or more of the problems related to multiple packet filter operations in TFT.

In a first aspect a method is performed by a wireless device for updating packet filters when interworking between Evolved Packet System, EPS, and Fifth Generation System, 5GS, networks is configured. The method comprising receiving a message to modify a packet data unit, PDU, session, the message comprising more than one packet filters to be updated wherein each of the more than one packet filters is associated with a same EPS bearer identity and the message indicates that the wireless device perform more than one traffic flow template operation. The TFT operations being the following operations: create new traffic flow template, TFT; delete existing TFT; add packet filters to existing TFT; replace packet filters in existing TFT; and delete packet filters from existing TFT. The method further includes the wireless device performing the updates for the identified EPS bearer and for the more than one packet filters associated with the EPS bearer identity.

In a second aspect a method is performed by a network node for updating packet filters when interworking between Evolved Packet System, EPS, and Fifth Generation System, 5GS, networks is supported. The method comprising creating a message to modify a packet data unit, PDU, session, the message comprising more than one packet filters to be updated wherein each of the more than one packet filters is associated with a same EPS bearer identity and the message indicates that a wireless device perform more than one traffic flow template operation, which consist of the following operations: create new traffic flow template, TFT; delete existing TFT; add packet filters to existing TFT; replace packet filters in existing TFT; and delete packet filters from existing TFT. The method proceeds with the network node transmitting, to a wireless device, the message comprising the updates for the identified EPS bearer and for the more than one packet filters associated with the EPS bearer identity.

In some examples of the first and the second aspect, the message comprises more than one EPS bearer context fields for the same EPS bearer identity and each EPS bearer context field comprises a single TFT operation code.

In some examples of the first or the second aspect the indication to perform more than one operation comprises receiving more than one TFT operation codes.

In some examples of the first or the second aspect at least two of the EPS bearer context fields are associated with the same TFT.

In some examples of the first or the second aspect at least two of the EPS bearer context fields associated with a TFT comprise different ones of a request to: add packet filters to existing TFT;

replace packet filters in existing TFT; and delete packet filters from existing TFT. For example, the EPS bearer context field comprises a request to add packet filters to existing TFT and a request to replace packet filters in existing TFT.

In some examples of the first or the second aspect an EPS bearer context field comprises more than one EPS parameter wherein each EPS parameter comprises a TFT operation code for updating one or more packet filters.

In some examples of the first or the second aspect the message comprises an EPS bearer context field which comprise an EPS parameter with a TFT operation code indicating to the wireless device to replace all packet filters in the existing TFT, wherein an EPS parameter lists all packet filters to be included for the EPS bearer and which replaces any previously defined packet filters for the EPS bearer. In some cases of this example the TFT operation code is defined using reserved bit value ‘111’.

In some examples of the first or the second aspect the message comprises at least one operation code associated with the EPS bearer identity indicating one of: create a new EPS bearer, delete an existing EPS bearer and modify an existing EPS bearer.

In some examples of the first or the second aspect the message comprises indicating more than one operation code associated with the EPS, such that more than one operation is requested for the EPS bearer identity.

In some examples of the first or the second aspect, for packet filters to be added or modified, a number of packet filters exceeds the length of a single EPS bearer context field and/or TFT field.

In a third aspect, a wireless device is provided. The wireless device is configured to receive a message to modify a packet data unit, PDU, session, the message comprising more than one packet filters to be updated wherein each of the more than one packet filters is associated with a same EPS bearer identity and the message indicates that the wireless device perform more than one traffic flow template operation, which are one of the following operations: create new traffic flow template, TFT; delete existing TFT; add packet filters to existing TFT; replace packet filters in existing TFT; and delete packet filters from existing TFT. The wireless device is further configured to perform the updates for the identified EPS bearer and for the more than one packet filters associated with the EPS bearer identity.

In further examples of the third aspect, the wireless device is configured to perform any of the methods described for the first aspect.

In a fourth aspect a network node is provided. The network node is configured to create a message to modify a packet data unit, PDU, session, the message comprising more than one packet filters to be updated wherein each of the more than one packet filters is associated with a same EPS bearer identity and the message indicates that a wireless device perform more than one traffic flow template operation, which are one of the following operations: create new traffic flow template, TFT; delete existing TFT; add packet filters to existing TFT; replace packet filters in existing TFT; and delete packet filters from existing TFT. The network node is further configured to transmit, to a wireless device, the message comprising the updates for the identified EPS bearer and for the more than one packet filters associated with the EPS bearer identity.

In some examples of the fourth aspect, the network node is configured to perform any of the methods of the second aspect.

In some examples of the fourth aspect, the network node is a session management function, SMF.

In a fifth aspect, a computer program, memory or carrier comprising a computer program is provided. The computer program comprises instructions which when executed on computer processing circuitry, cause the computer to perform any one of the methods described for the first or the second aspect.

### BRIEF DESCRIPTION OF THE DRAWINGS

FIG. 1 is a signalling diagram illustrating an example of an initial protocol data unit (PDU) session establishment with interworking.

FIG. 2 is a signalling diagram illustrating an example of the current method of updating a PCC rule.

FIG. 3 is a signalling diagram illustrating an example according to one or more embodiments of the present disclosure.

FIG. 4 is a signalling diagram illustrating an example according to one or more embodiments of the present disclosure.

FIG. 5 is a signalling diagram illustrating an example according to one or more embodiments of the present disclosure.

FIG. 6 shows a Network-requested PDU session modification procedure.

FIG. 7 is a flow diagram illustrating an example method according to one or more embodiments of the present disclosure.

FIG. 8 is a flow diagram illustrating an example method according to one or more embodiments of the present disclosure.

FIG. 9 shows an example of a communication system in accordance with some embodiments.

FIG. 10 shows a UE in accordance with some embodiments.

FIG. 11 shows a network node in accordance with some embodiments.

FIG. 12 is a block diagram of a host, which may be an embodiment of the host of FIG. 9.

FIG. 13 is a block diagram illustrating a virtualization environment in which functions implemented by some embodiments may be virtualized.

FIG. 14 shows a communication diagram of a host communicating via a network node with a UE over a partially wireless connection in accordance with some embodiments.

### DETAILED DESCRIPTION

Each QoS rule or TFT only supports one operation code at a time. TFT operation codes differ slightly between the two radio systems and in certain scenarios, it can become challenging to keep the TFT and QoS rule(s) packet filters synchronized without sending multiple messages; in particular the TFT packet filters.

For example, during protocol data unit (PDU) session establishment with IWK, the Policy Control Function (PCF) instructs the Session Management Function (SMF) to install a PCC rule with 3 flow descriptions (“1”, “2”, and “3”), then the following will be created:
QoS rule with the operation code “Create new QoS flow” with three packet filters;
EPS bearer context with operation code “Create new EPS bearer” containing a TFT with operation code “Create new TFT” and 3 packet filters.

These are then sent to the UE via the Access and Mobility Management Function (AMF) in a Namf_Communication_N1N2MessageTransfer Request.

At a later time, the PCF decides to update the PCC rule with the following flow descriptions:
Add a new flow description “4”
Modify flow description “2”
Delete flow description “3”
Flow “1” is unmentioned, and thus will be unchanged.

This prompts the SMF to send PDU SESSION MODIFICATION COMMAND with the Authorized QoS rules IE with a QoS rule (with the same ID as the previous one) with the operation code “Modify existing QoS flow and replace all packet filters” with 3 packet filters associated with flow “4”, modified “2”, and “1”. Thus, the QoS rule's packet filters can be synchronized according to the PCFs instructions in one message.

To update the EPS bearer packet filters, multiple messages containing a Mapped EPS Bearer Context would be required, because there is no equivalent “replace all” operation code for TFT and multiple operations would need to be performed to replicate QoS rule's “replace all.” These operations can be conducted in different steps, but one possible sequence of operations is to create 3 Mapped EPS bearer contexts, each with “Modify existing EPS bearer” operation code and the three following TFT IEs respectively:
TFT with operation code “Delete packet filters from existing TFT” and reference the packet filter associated with flow “3” to remove it
TFT with operation code “Replace packet filters in existing TFT” and replace the original packet filter associated with flow “2” with the modified version
TFT with operation code “Add packet filters to existing TFT” and add the new packet filter associated with flow “4”

Only one EPS Bearer context with a unique EBI is included in each message, three messages would need to be sent. If operating in a 5G context this means that three Namf_Communication_N1N2MessageTransfers must be sent. In 4G, three Update Bearer messages must be sent.

The extra signaling is detrimental from a performance perspective and in the interim collisions or interfering messages may cause various and possibly undefined behaviours. There is also a period where the QoS flow and EPS bearer packet filters will be out of synchronization and traffic will not be mapped properly.

Certain aspects of the disclosure and their embodiments may provide solutions to these or other challenges. For example, particular embodiments send (e.g., by SMF to UE) all the updated packet filters in one message for the interworking scenario. Three alternatives are proposed:

Alternative 1: Use multiple EPS Bearer Context with the same EBI in Mapped EPS bearer contexts IE. Based on the example above, this alternative includes the 3 different Mapped EPS Bearer context in Mapped EPS bearer contexts IE within the same Namf_Communcation N1N2MessageTransfer or Update Bearer for 5G/4G, respectively. In general, the UE would process multiple EPS Bearer Context that contain the same EBI in one EPS bearer contexts IE, concatenates the information, and updates the specified EPS bearer information (such as packet filters) contained inside all the EPS Bearer Contexts.

Alternative 2: Uses a new TFT operation code: “Replace all packet filters in existing TFT.” The reserved TFT operation code bit may be used for the new TFT operation code. This operation replaces all the existing TFT packet filters with the packet filters included in the IE. This is similar to the equivalent QoS rule operation code.

Alternative 3: Send multiple TFT IEs inside a Mapped EPS Bearer Context. Currently, TFT is encoded inside the EPS parameters list. The EPS parameter identifier assigned to TFT is 03H. Multiple EPS parameters with the EPS parameter identifier (03H) need to be processed for this alternative.

For alternative 2, the UE and SMF should negotiate the support of any of the proposed alternatives. This may be via the Extended Protocol Configuration IE that is exchanged during PDU Session Establishment procedure.

Alternative 1 and 3 may require negotiation of support for these alternatives.

Certain embodiments may provide one or more of the following technical advantages. For example, particular embodiments reduce signaling in the network, ensure that the EPS bearer and QoS flow packet filters are always synchronized, and reduce the chances of encountering undefined behavior due to excessive signaling.

Some of the embodiments contemplated herein will now be described more fully with reference to the accompanying drawings. Embodiments are provided by way of example to convey the scope of the subject matter to those skilled in the art. Additional information may also be found in the Appendix.

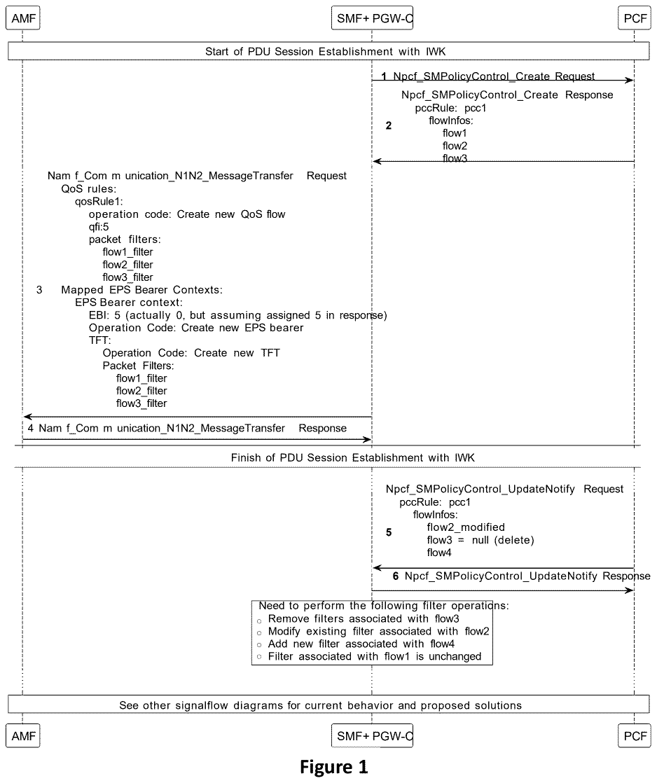

FIG. 1 is a flow diagram illustrating an example initial protocol data unit (PDU) session establishment with interworking. Setup includes the following steps.

Step 1. The SMF sends a Npcf SMPolicyControl Create Request to the PCF as part of the PDU Session Establishment procedure.

Step 2: The PCF responds and asks the SMF to install a PCC Rule (pcc1) that has 3 flow descriptions (flow1, flow2, and flow3).

Step 3: The SMF sends a Namf_Communication_N1N2MessageTransfer Request with a QoS rule with the 3 packet filters and a Mapped EPS bearer context in Mapped EPS bearer contexts IE with a TFT containing the same 3 packet filters.

Step 4: The AMF sends a response.

Step 5: The PCF sends a Npcf_SMPolicyControl_UpdateNotify Request, updating the PCC rule. It modifies the flow description of flow2, deletes flow3, and adds new flow4.

Step 6: The SMF sends a response to the PCF.

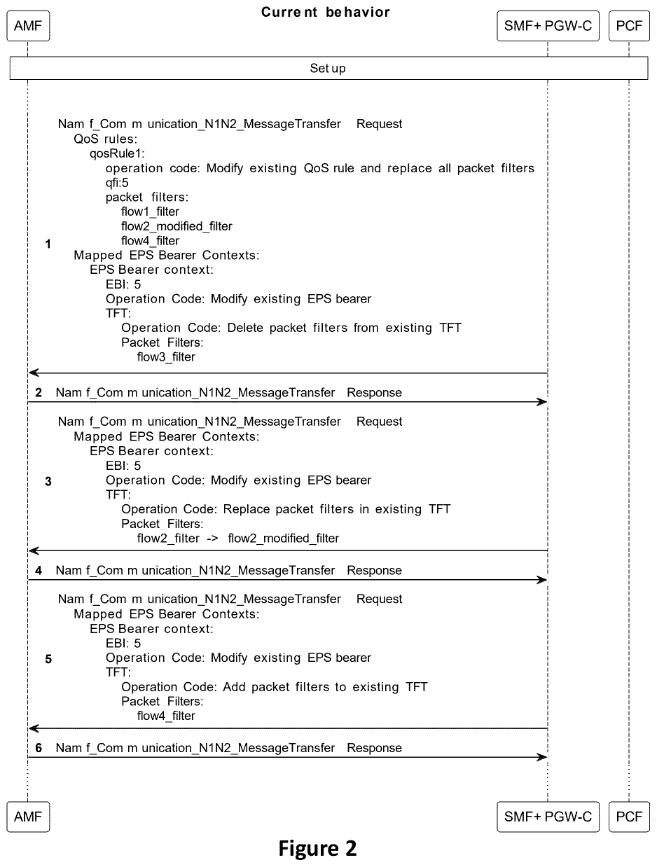

FIG. 2 is a flow diagram illustrates an example of the current method of updating a PCC rule. The update includes the following steps.

Step 1: The SMF sends a Namf_Communication_N1N2MessageTransfer Request with a QoS rule with the “replace all” operation code and flow1, the modified flow2, and flow 4. The Mapped EPS Bearer contains a TFT that deletes flow3.

Step 2: The AMF sends a response.

Step 3: Another Namf_Communication_N1N2MessageTransfer Request is sent that contains a Mapped EPS Bearer with a TFT that replaces flow2 with the modified flow2.

Step 4: The AMF sends a response.

Step 5: A final Namf_Communication_N1N2MessageTransfer Request is sent with a Mapped EPS Bearer with a TFT that adds flow4.

Step 6: The AMF sends a response.

According to some embodiments, the update procedure may include any of the following alternative.

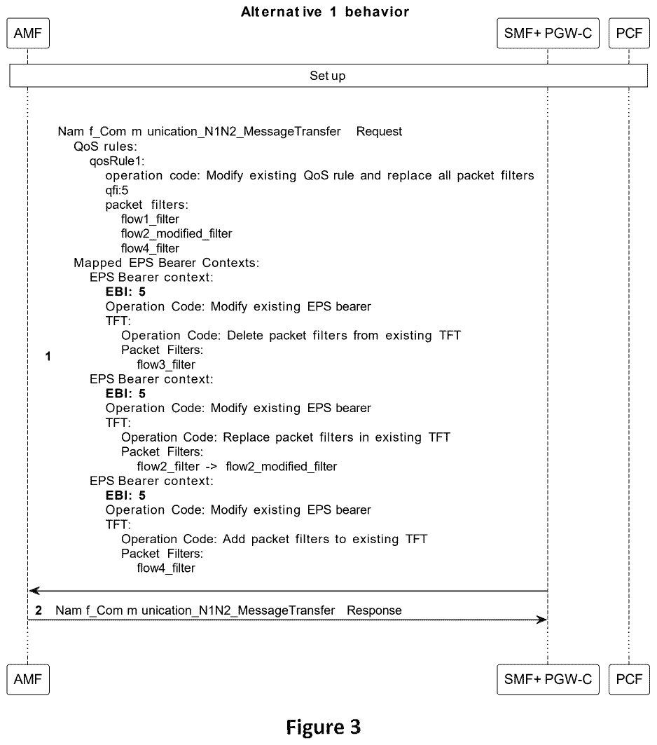

FIG. 3 is a flow diagram illustrating an example of alternative 1. The update procedure includes the following steps.

Step 1: The SMF sends a Namf_Communication_N1N2MessageTransfer Request to update the QoS rule as specified in message 1 of the current behavior. Three Mapped EPS bearer context are included in Mapped EPS bearer context IE that all have the same EBI and perform the same operations as specified in messages 7, 9, and 11 respectively. Thus, all the QoS rule and TFT packet filters are updated in one message.

Step 2: The AMF sends a response.

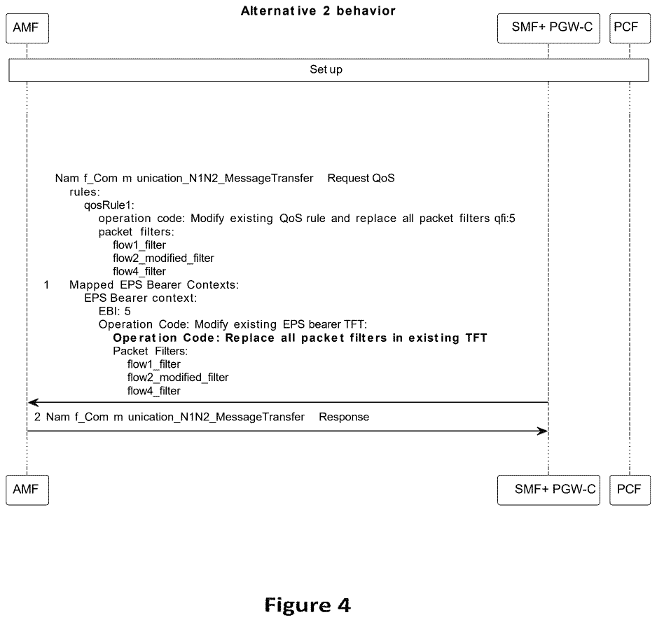

FIG. 4 is a flow diagram illustrating an example of alternative 2. The update procedure includes the following steps.

Step 1: The SMF sends a Namf_Communication_N1N2MessageTransfer Request to update the QoS rule as specified in message 1 of the current behavior. It also includes one Mapped EPS bearer context that contains a TFT with the proposed operation code “Replace all packet filters in existing TFT.” By synchronizing the TFT and QoS rule operation codes, the packet filters may be kept up to date in one message.

Step 2: The AMF sends a response.

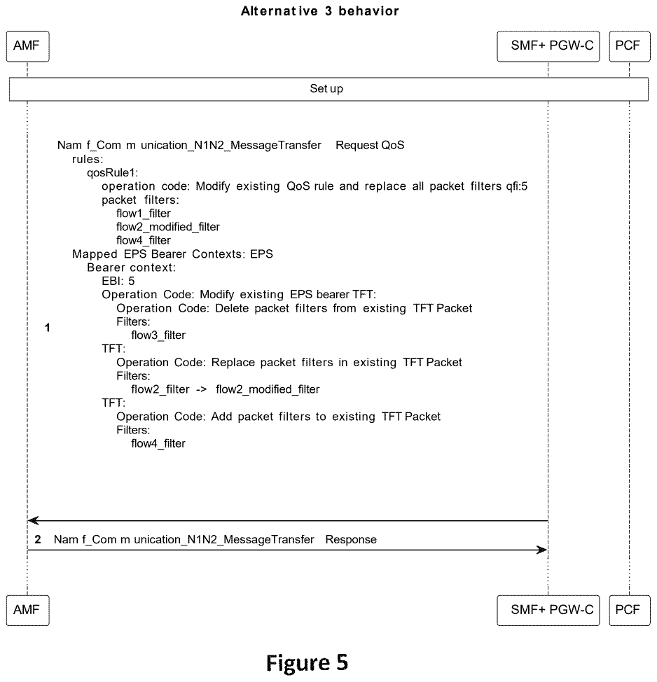

FIG. 5 is a flow diagram illustrating an example of alternative 3. The update procedure includes the following steps.

Step 1: The SMF sends a Namf_Communication_N1N2MessageTransfer Request to update the QoS rule as specified in message 1 of the current behavior. It also includes one Mapped EPS bearer context that contains three TFT (3 EPS parameter identifier 03H). Each TFT has its corresponding operation code.

The EPS parameter identifier field is used to identify each EPS parameter included in the EPS parameters list and it contains the hexadecimal coding of the EPS parameter identifier. Bit 8 of the EPS parameter identifier field contains the most significant bit and bit 1 contains the least significant bit. In this version of the protocol, the following EPS parameter identifiers are specified:
01H (Mapped EPS QoS parameters);
02H (Mapped extended EPS QoS parameters);
03H (Traffic flow template);
04H (APN-AMBR); and
05H (extended APN-AMBR).

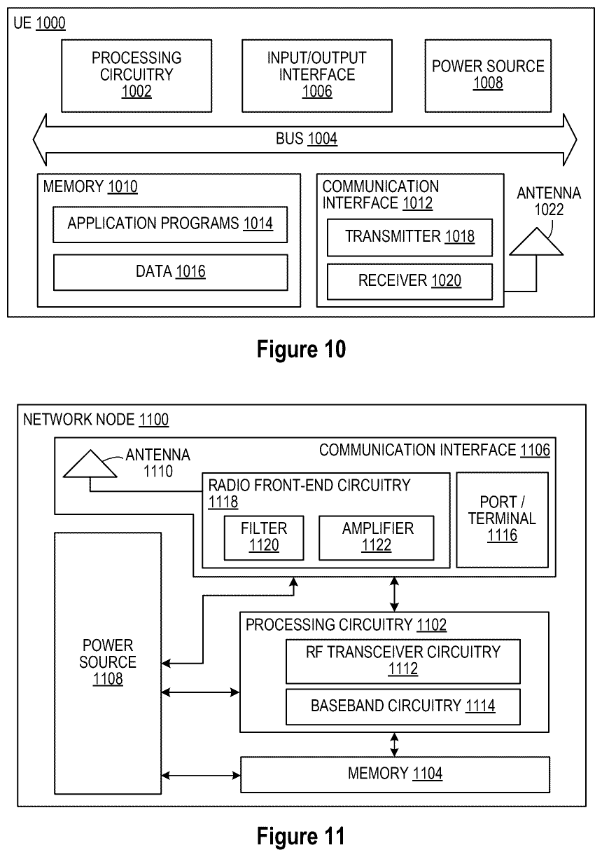

When the parameter identifier indicates traffic flow template, the length and parameter contents field are coded from octet 2 as shown FIG. 10.5.144 and table 10.5.16.2 of 3GPP TS 24.008 V18.0.0, replicated below as Table 1

TABLE 1
Traffic flow template information element

| | | | | | | | |
|---|---|---|---|---|---|---|---|
| 8 | 7 | 6 | 5 | 4 | 3 | 2 | 1 |

| Traffic flow template IEI | | | Octet 1 |
|---|---|---|---|
| Length of traffic flow template IE | | | Octet 2 |
| TFT operation | E bit | Number of packet | Octet 3 |
| code | | filters | |

| Packet filter list | Octet 4 |
|---|---|
| | Octet z |
| Parameters list | Octet |
| | (z + 1)* |
| | Octet v* |

TFT operation code (octet 3), Bits 8, 7, 6:
0 0 0 Ignore this IE
0 0 1 Create new TFT
0 1 0 Delete existing TFT
0 1 1 Add packet filters to existing TFT
1 0 0 Replace packet filters in existing TFT
1 0 1 Delete packet filters from existing TFT
1 1 0 No TFT operation
1 1 1 Reserved

Some of the examples above may be summarized as follows:

Case 1: There are 3 packet filters (filters 1-3) in the QoS rule for dedicated QoS flow (map to EBI 5). If PCF requests to:
packet filter 1: →remove
packet filter 2: →update to packet filter 2′
packet filter 3: no change
packet filter 4 (new): →add

Alt-1:

Mapped EPS bearer contexts IE:
Mapped EPS bearer context
   EPS bearer identity (5)
   Operation code (Modify existing EPS bearer)
   Number of EPS parameters (1)
   EPS parameters list
      EPS parameter identifier (03H: TFT)
      EPS parameter contents: TFT operation code (Delete packet filters from existing TFT), packet filter identifier (1) . . .
Mapped EPS bearer context
   EPS bearer identity (5)
   Operation code (Modify existing EPS bearer)
   Number of EPS parameters (1)
      EPS parameters list
      EPS parameter identifier (03H: TFT) EPS parameter contents: TFT operation code (Replace packet filters in existing TFT), packet filter identifier (2) . . .
Mapped EPS bearer context
   EPS bearer identity (5)
   Operation code (Modify existing EPS bearer)
   Number of EPS parameters (1)
   EPS parameters list
      EPS parameter identifier (03H: TFT)
      EPS parameter contents: TFT operation code (Add packet filters to existing TFT), packet filter identifier (4) . . .

Alt-3:

Mapped EPS bearer contexts IE:
Mapped EPS bearer context
   EPS bearer identity (5)
   Operation code (Modify existing EPS bearer)
   Number of EPS parameters (3)
   EPS parameters list
      EPS parameter identifier (03H: TFT)
      EPS parameter contents: TFT operation code (Delete packet filters from existing TFT), packet filter identifier (1) . . .
      EPS parameter identifier (03H: TFT)
      EPS parameter contents: TFT operation code (Replace packet filters in existing TFT), packet filter identifier (2) . . .
      EPS parameter identifier (03H: TFT)
      EPS parameter contents: TFT operation code (Add packet filters to existing TFT), packet filter identifier (4) . . .

An additional example is summarized below.

Case 2: There are 5 maximum size IPV6 packet filters (filters 1-5) in the QoS rule for dedicated QoS flow (map to EBI 5). Assume they are provisioned by PCF during PDU session establishment procedure.

Packet filter 1 to 5 shall be sent to UE in Mapped EPS bearer contexts IE. When the EPS parameter identifier is set to 03H (TFT), the coding follows TFT IE in 24.008, the maximum TFT IE is 257 octets which can only contain 4 IPv6 maximum size packet filters. So without following one of the disclosed alternatives, the packet filters 1-5 has to be divided into 2 parts, and sent to UE in 2 messages.

Alt-1:

Mapped EPS bearer contexts IE:
Mapped EPS bearer context
   EPS bearer identity (5)
   Operation code (Create new EPS bearer)
   Number of EPS parameters (1)
   EPS parameters list
      EPS parameter identifier (03H: TFT)
      EPS parameter contents: TFT operation code (Create new TFT), packet filter identifier (1)+content, packet filter identifier (2)+content, packet filter identifier (3)+content, packet filter identifier (4)+content
Mapped EPS bearer context
   EPS bearer identity (5)
   Operation code (Modify existing EPS bearer)
   Number of EPS parameters (1)
   EPS parameters list
      EPS parameter identifier (03H: TFT)
      EPS parameter contents: TFT operation code (Add packet filters to existing TFT), packet filter identifier (5)+content

Alt-3:

Mapped EPS bearer contexts IE:
Mapped EPS bearer context
   EPS bearer identity (5)
   Operation code (Create new EPS bearer)
   Number of EPS parameters (2)
   EPS parameters list
      EPS parameter identifier (03H: TFT)
      EPS parameter contents: TFT operation code (Create new TFT), packet filter identifier (1)+content, packet filter identifier (2)+content, packet filter identifier (3)+content, packet filter identifier (4)+content
      EPS parameter identifier (03H: TFT)
      EPS parameter contents: TFT operation code (Add packet filters to existing TFT), packet filter identifier (5)+content.

Certain embodiments will now be described in further detail and conjunction with corresponding figures.

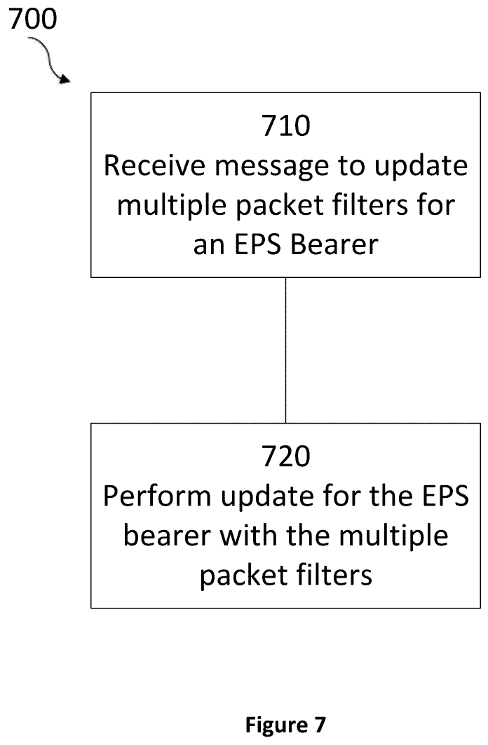

In FIG. 7 a method 700 is depicted. The method 700 is performed by a wireless device for updating packet filters. In some examples the wireless device is operating in communications network which supports and is configured to interwork between Evolved Packet System, EPS, and Fifth Generation System, 5GS, networks. The method 700 involves the wireless device receiving 710 a message to modify a packet data unit, PDU, session. The message includes a request to update more than one packet filters for an EPS bearer. The EPS bearer is identified by an EPS bearer identity (EBI). Specifically, each of the more than one packet filters is associated with a same EPS bearer identity (EBI). The message furthermore indicates that the wireless device perform more than one traffic flow template operations. For example the message may require at least two of the following operations: create new traffic flow template, TFT; delete existing TFT; add packet filters to existing TFT; replace packet filters in existing TFT; delete packet filters from existing TFT. In some examples the message may indicate these two or more operations as a specific single TFT operation which directs the wireless device to perform the combination of operations. For example to update existing packet filters of a TFT operation could correspond to the TFT operation for deleting some packet filters from existing TFT and the TFT operation for adding some packet filters to the existing TFT and the TFT operation for replacing some packet filters with new packet filters for the existing TFT. In other examples the message may comprise multiple TFT operations so perform the tasks in a stepwise manner but signalled in the single message associated with the same EPS bearer identity. The method proceeds with the wireless device performing 720 the updates for the identified EPS bearer and for the more than one packet filters.

In some examples of this method, the message comprises more than one EPS bearer context fields for the same EPS bearer identity and each EPS bearer context field comprises a single TFT operation code. In some examples of the method, the indication to perform more than one operation comprises receiving more than one TFT operation codes. For example each EPS bearer context field may include a single EPS parameter which includes one TFT operation code. Then in order to indicate multiple packet filters to be updated, the separate TFT operations are performed by separate EPS bearer context fields which use the same EPS bearer identity. This corresponds to Alternative 1 as described previously. In other examples the multiple TFT operations may be indicated by including the multiple TFT operation within multiple EPS parameters within a single EPS bearer context (which indicates the EPS Bearer identity). This example corresponds to Alternative 3 described previously. In other words an EPS bearer context field comprises more than one EPS parameter wherein each EPS parameter comprises a TFT operation code for updating one or more packet filters

In some examples at least two of the EPS bearer context fields are associated with the same TFT.

In at least some of the previously described examples at least two of the EPS bearer context fields associated with a TFT comprise different ones of a request to: add packet filters to existing TFT; replace packet filters in existing TFT; and delete packet filters from existing TFT.

In some examples the message comprises an EPS bearer context field which comprise an EPS parameter with a TFT operation code indicating to the wireless device to replace all packet filters in the existing TFT, wherein an EPS parameter lists all packet filters to be included for the EPS bearer and which replaces any previously defined packet filters for the EPS bearer. This example corresponds to Alternative 2 as previously described. In some examples this TFT operation code is defined using reserved bit value ‘111’.

In some examples of the method, the message comprises at least one operation code associated with the EPS bearer identity indicating one of: create a new EPS bearer; delete an existing EPS bearer; and modify an existing EPS bearer. In some examples the message comprises indicating more than one operation code associated with the EPS, such that more than one operation is requested for the EPS bearer identity in the same message.

In some examples the packet filters to be added or modified exceeds the length of a single EPS bearer context field and/or TFT field and hence the TFT operation has to be requested with separate EPS bearer contexts or separate EPS bearer parameters for the same EPS bearer identity.

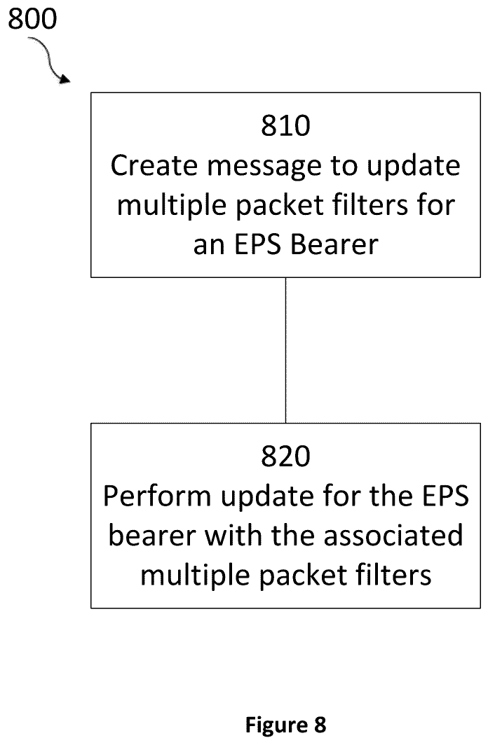

In FIG. 8 a method 800 performed by a network node for updating packet filters is provided. The network node is operating in a communications network which supports and is configured to interwork between Evolved Packet System, EPS, and Fifth Generation System, 5GS, networks. The method 800 involves the network node creating 810 a message to update or modify a packet data unit, PDU, session. The message is created to request a wireless device to update more than one packet filters wherein each of the more than one packet filters is associated with a same EPS bearer identity. The message instructs the wireless device to update the packet filters associated to a traffic flow template (TFT) by indicating more than one TFT operations. For example the message includes an indicate for the wireless device to perform two or more of the following operations: create new traffic flow template, TFT; delete existing TFT; add packet filters to existing TFT; replace packet filters in existing TFT; and delete packet filters from existing TFT.

The method proceeds with the network node transmitting 820, to the wireless device, the message comprising the request for performing the updates to the identified EPS bearer and for the more than one packet filters associated with the EPS bearer identity.

In some examples of this method, the message comprises more than one EPS bearer context fields for the same EPS bearer identity and each EPS bearer context field comprises a single TFT operation code.

In some examples the indication to perform more than one operation comprises indicating more than one TFT operation codes. In some examples at least two of the EPS bearer context fields are associated with the same TFT. In some examples the TFT is to be modified and at least two of the EPS bearer context fields associated with the TFT comprise different ones of a request to; add packet filters to existing TFT; replace packet filters in existing TFT; and delete packet filters from existing TFT. In some examples an EPS bearer context field comprises more than one EPS parameter wherein each EPS parameter comprises a TFT operation code for updating one or more packet filters. In some examples the message comprises an EPS bearer context field which comprise an EPS parameter with a TFT operation code indicating to the wireless device to replace all packet filters in the existing TFT, wherein an EPS parameter lists all packet filters to be included for the EPS bearer and which replaces any previously defined packet filters for the EPS bearer. In some examples the TFT operation code is defined using reserved bit value ‘111’.

In some examples the message comprises at least one operation code associated with the EPS bearer identity indicating one of: create a new EPS bearer; delete an existing EPS bearer; and modify an existing EPS bearer. In further examples the message comprises indicating more than one operation code associated with the EPS, such that more than one operation is requested for the EPS bearer identity.

In some examples the packet filters to be added or modified exceed the length of a single EPS bearer context field and/or TFT field and hence the TFT operation is requested with separate EPS bearer contexts or separate EPS bearer parameters for the same EPS bearer identity.

In some examples the network node is a session management function, SMF. An SMF may be a logical function in physical hardware which performs many functions including those attributed to session management, and more particularly to the embodiments disclosed herein pertaining to a network node. In other examples an SMF may be implemented a virtual network function implemented on a virtual machine as described with respect to FIG. 13.

The following is an example of how certain embodiments disclosed herein may be specified as part of a 3GPP standard text according to particular embodiments

To initiate the network-requested PDU session modification procedure, the SMF shall create a PDU SESSION MODIFICATION COMMAND message.

If the authorized QoS rules of the PDU session is modified or is marked as to be synchronized with the UE, the SMF shall set the Authorized QoS rules IE of the PDU SESSION MODIFICATION COMMAND message to the authorized QoS rules of the PDU session. The SMF shall ensure that the number of the packet filters used in the authorized QoS rules of the PDU Session does not exceed the maximum number of packet filters supported by the UE for the PDU session. The SMF may bind service data flows for which the UE has requested traffic segregation to a dedicated QoS flow for the PDU session, if possible. Otherwise, the SMF may bind the service data flows to an existing QoS flow. The SMF shall use only one dedicated QoS flow for traffic segregation. If the UE has requested traffic segregation for multiple service data flows with different QoS handling, the SMF shall bind all these service data flows to a single

QoS flow. If the SMF allows traffic segregation for service data flows in a QoS rule, then the SMF shall create a new authorized QoS rule for these service data flows and shall delete packet filters corresponding to these service data flows from the other authorized QoS rules. If the authorized QoS flow descriptions of the PDU session is modified or is marked as to be synchronized with the UE, the SMF shall set the Authorized QoS flow descriptions IE of the PDU SESSION MODIFICATION COMMAND message to the authorized QoS flow descriptions of the PDU session.

If SMF creates a new authorized QoS rule for a new QoS flow, then SMF shall include the authorized QoS flow description for that QoS flow in the Authorized QoS flow descriptions IE of the PDU SESSION MODIFICATION COMMAND message, if:
a) the newly created authorized QoS rules is for a new GBR QoS flow;
b) the QFI of the new QoS flow is not the same as the 5QI of the QoS flow identified by the QFI;
c) the new QoS flow can be mapped to an EPS bearer as specified in subclause 4.11.1 of 3GPP TS 23.502 V17.6.0; or
d) the new QoS flow is established for the PDU session used for relaying, as specified in subclause 5.6.2.1 of 3GPP TS 23.304 V17.4.0.
NOTE 0: In cases other than above listed cases, it is up to the SMF implementation to include the authorized QoS flow description of the new QoS flow for the new authorized QoS rule in the Authorized QoS flow descriptions IE of the PDU SESSION MODIFICATION COMMAND message.

If the session-AMBR of the PDU session is modified, the SMF shall set the selected Session-AMBR IE of the PDU SESSION MODIFICATION COMMAND message to the session-AMBR of the PDU session.

If interworking with EPS is supported for the PDU session and if the mapped EPS bearer contexts of the PDU session is modified, the SMF shall set the Mapped EPS bearer contexts IE of the PDU SESSION MODIFICATION COMMAND message to the mapped EPS bearer contexts of the PDU session. If the association between a QoS flow and the mapped EPS bearer context is changed, the SMF shall set the EPS bearer identity parameter in Authorized QoS flow descriptions IE of the PDU SESSION MODIFICATION COMMAND message to the new EPS bearer identity associated with the QoS flow. If the change of packet filters results one or more TFT operation codes are needed to get the packet filters updated, the SMF may include multiple Mapped EPS bearer context parameter with the same EPS bearer identity in the Mapped EPS bearer contexts IE of the PDU SESSION MODIFICATION COMMAND message.

If the network-requested PDU session modification procedure is triggered by a UE-requested PDU session modification procedure and the PDU SESSION MODIFICATION REQUEST message includes a 5GSM capability IE, the SMF shall:
a) if the RQoS bit is set to:
   1) “Reflective QoS supported”, consider that the UE supports reflective QoS for this PDU session; or
   2) “Reflective QoS not supported”, consider that the UE does not support reflective Qos for this PDU session; and;
b) if the MH6-PDU bit is set to:
   1) “Multi-homed IPV6 PDU session supported”, consider that this PDU session is supported to use multiple IPv6 prefixes; or
   2) “Multi-homed IPV6 PDU session not supported”, consider that this PDU session is not supported to use multiple IPv6 prefixes.

If the SMF considers that reflective QoS is supported for QoS flows belonging to this PDU session, the SMF may include the RQ timer IE set to an RQ timer value in the PDU SESSION MODIFICATION COMMAND message.

If a port management information container needs to be delivered (see 3GPP TS 23.501V17.6.0 and 3GPP TS 23.502 V17.6.0) and the UE has set the TPMIC bit to “Transport of port management information container supported” in the 5GSM capability IE, the SMF shall include a Port management information container IE in the PDU SESSION MODIFICATION COMMAND message.

For a PDN connection established when in S1 mode, upon the first inter-system change from S1 mode to N1 mode, if the network-requested PDU session modification procedure is triggered by a UE-requested PDU session modification procedure, the PDU session type is “IPv4”, “Ipv6”, “Ipv4v6” or “Ethernet” and the PDU SESSION MODIFICATION REQUEST message includes a Maximum number of supported packet filters IE, the SMF shall consider this number as the maximum number of packet filters that can be supported by the UE for this PDU session. Otherwise the SMF considers that the UE supports 16 packet filters for this PDU session. For a PDN connection established when in S1 mode, upon the first inter-system change from S1 mode to N1 mode, if the network-requested PDU session modification procedure is triggered by a UE-requested PDU session modification procedure, the SMF shall consider that the maximum data rate per UE for user-plane integrity protection supported by the UE for uplink and the maximum data rate per UE for user-plane integrity protection supported by the UE for downlink are valid for the lifetime of the PDU session.

For a PDN connection established when in S1 mode, upon the first inter-system change from S1 mode to N1 mode, if the network-requested PDU session modification procedure is triggered by a UE-requested PDU session modification procedure and the SMF determines, based on local policies or configurations in the SMF and the Always-on PDU session requested IE in the PDU SESSION MODIFICATION REQUEST message (if available), that either:
a) the requested PDU session needs to be an always-on PDU session, the SMF shall include the Always-on PDU session indication IE in the PDU SESSION MODIFICATION COMMAND message and shall set the value to “Always-on PDU session required”; or
b) the requested PDU session shall not be an always-on PDU session and:
   1) if the UE included the Always-on PDU session requested IE, the SMF shall include the Always-on PDU session indication IE in the PDU SESSION MODIFICATION COMMAND message and shall set the value to “Always-on PDU session not allowed”; or
   2) if the UE did not include the Always-on PDU session requested IE, the SMF shall not include the Always-on PDU session indication IE in the PDU SESSION MODIFICATION COMMAND message.

For a PDN connection established when in S1 mode, upon the first inter-system change from S1 mode to N1 mode, if the network-requested PDU session modification procedure is triggered by a UE-requested PDU session modification procedure, the UE supports EDC and the network allows the use of EDC, then the SMF shall include the Extended protocol configuration options IE in the PDU SESSION MODIFICATION COMMAND message with the EDC usage allowed indicator.

For a PDN connection established when in S1 mode, upon the first inter-system change from S1 mode to N1 mode, if the network-requested PDU session modification procedure is triggered by a UE-requested PDU session modification procedure, the UE supports EDC and the network requires the use of EDC, then the SMF shall include the Extended protocol configuration options IE in the PDU SESSION MODIFICATION COMMAND message with the EDC usage required indicator.

If a QoS flow for URLLC is created in a PDU session and the SMF has not provided the Always-on PDU session indication IE with the value set to “Always-on PDU session required” in the UE-requested PDU session establishment procedure or a network-requested PDU session modification procedure for the PDU session, the SMF shall include the Always-on PDU session indication IE in the PDU SESSION MODIFICATION COMMAND message and shall set the value to “Always-on PDU session required”.

If the value of the RQ timer is set to “deactivated” or has a value of zero, the UE considers that RqoS is not applied for this PDU session and remove the derived QoS rule(s) associated with the PDU session, if any.

If the network-requested PDU session modification procedure is triggered by a UE-requested PDU session modification procedure, the SMF shall set the PTI IE of the PDU SESSION MODIFICATION COMMAND message to the PTI of the PDU SESSION MODIFICATION REQUEST message received as part of the UE-requested PDU session modification procedure. If the network-requested PDU session modification procedure is triggered by a UE-requested PDU session modification procedure and the UE has included the Requested MBS container IE in the PDU SESSION MODIFICATION REQUEST message with the MBS operation set to “Join MBS session”, the SMF:
a) shall include the TMGI for the MBS session IDs that the UE is allowed to join, if any, in the Received MBS container IE, shall set the MBS decision to “MBS join is accepted” for each of those Received MBS information, may include the MBS start time to indicate the time when the MBS session starts, and shall include the MBS security container in each of those Received MBS information if security protection is applied for that MBS session and the control plane security procedure is used as specified in annex W.4.1.2 in 3GPP TS 33.501 V17.7.0, and shall use separate QoS flows dedicated for multicast by including the Authorized QoS flow descriptions IE if no separate QoS flows dedicated for multicast exist or if the SMF wants to establish new QoS flows dedicated for multicast;
NOTE 1: The network determines whether security protection applies or not for the MBS session as specified in 3GPP TS 33.501 V17.7.0.
b) shall include the TMGI for MBS session IDs that the UE is rejected to join, if any, in the Received MBS container IE, shall set the MBS decision to “MBS join is rejected” for each of those Received MBS information, shall set the Rejection cause for each of those Received MBS information with the reason of rejection and, if the Rejection cause is set to “MBS session has not started or will not start soon”, may include an MBS back-off timer value; and
c) may include in the Received MBS container IE the MBS service area for each MBS session and include in it the MBS TAI list, the NR CGI list or both, that identify the service area(s) for the local MBS service;
NOTE 2: For an MBS multicast session that has multiple MBS service areas, the MBS service areas are indicated to the UE using MBS service announcement as described in 3GPP TS 23.247 V17.4.0, which is out of scope of this specification.
   in the PDU SESSION MODIFICATION COMMAND message. If the UE has set the Type of MBS session ID to “Source specific IP multicast address” in the Requested MBS container IE for certain MBS session(s) in the PDU SESSION MODIFICATION REQUEST message, the SMF shall include the Source IP address information and Destination IP address information in the Received MBS information together with the TMGI for each of those MBS sessions.
NOTE 3: Including the Source IP address information and Destination IP address information in the Received MBS information in that case is to allow the UE to perform the mapping between the requested MBS session ID and the provided TMGI.
NOTE 4: In SNPN, TMGI is used together with NID to identify an MBS Session.

### If:

a) the SMF wants to remove joined UE from one or more MBS sessions; or
b) the network-requested PDU session modification procedure is triggered by a UE-requested PDU session modification procedure and the UE has included the Requested MBS container IE in the PDU SESSION MODIFICATION REQUEST message with the MBS operation set to “Leave MBS session”,
   the SMF shall include the MBS session IDs that the UE is removed from, if any, in the Received MBS container IE in the PDU SESSION MODIFICATION COMMAND message and shall set the MBS decision to “Remove UE from MBS session” for each of those Received MBS information. The SMF may include the updated MBS service area in each of the Received MBS information, if any. The SMF may delete the QoS flows associated for the multicast by including the Authorized QoS flow descriptions IE in the PDU SESSION MODIFICATION COMMAND message. If the UE is removed from MBS session due to the MBS session release, the SMF shall set the Rejection cause to “MBS session is released”. The SMF shall include the Rejection cause for each of the Received MBS information, if any, and set its value with the reason of removing the UE from the corresponding MBS session.
NOTE 5: based on operator's policy, e.g., after a locally configured time period, the SMF is allowed to trigger the removal of joined UE from an MBS session when the UE moves outside all the MBS service area(s) of that MBS session.

If the SMF wants to update the MBS security information of an MBS session that the UE has joined, the SMF shall include the corresponding MBS session ID and the MBS security container in the Received MBS container IE in the PDU SESSION MODIFICATION COMMAND message and shall set the MBS Decision to “MBS security information update” in the Received MBS information.

If the SMF wants to update the MBS service area of an MBS session that the UE has joined, the SMF shall include the corresponding MBS session ID and the updated MBS service area in the Received MBS container IE in the PDU SESSION MODIFICATION COMMAND message, and shall set the MBS decision to “MBS service area update” in the Received MBS information.
NOTE 6: The MBS service area of an MBS multicast session is also allowed to be updated to the UE using the MBS service announcement as described in 3GPP TS 23.247 V17.4.0, which is out of scope of this specification.

If the network needs to update ATSSS parameters (see subclause 5.2.4 of 3GPP TS 24.193 V17.6.0), the SMF shall include the ATSSS container IE with the updates of ATSSS parameters in the PDU SESSION MODIFICATION COMMAND message.

If the network-requested PDU session modification procedure is not triggered by a UE-requested PDU session modification procedure, the SMF shall set the PTI IE of the PDU SESSION MODIFICATION COMMAND message to “No procedure transaction identity assigned”.

If the selected SSC mode of the PDU session is “SSC mode 3” and the SMF requests the relocation of SSC mode 3 PDU session anchor with multiple PDU sessions as specified in 3GPP TS 23.502 V17.6.0, the SMF shall include 5GSM cause #39 “reactivation requested”, in the PDU SESSION MODIFICATION COMMAND message, and may include the PDU session address lifetime in a PDU session address lifetime parameter in the Extended protocol configuration options IE of the PDU SESSION MODIFICATION COMMAND message.

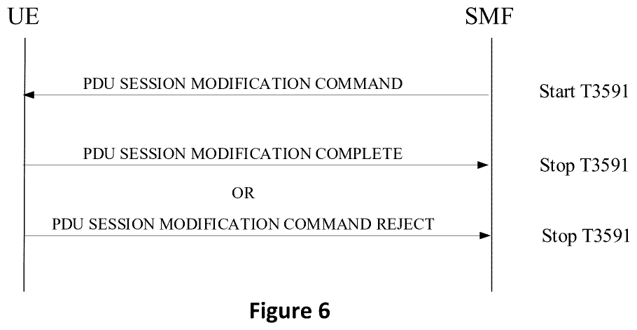

The SMF shall send the PDU SESSION MODIFICATION COMMAND message, and the SMF shall start timer T3591 (see example in FIG. 6).
NOTE 7: If the SMF requests the relocation of SSC mode 3 PDU session anchor with multiple PDU sessions as specified in 3GPP TS 23.502 V17.6.0, the reallocation requested indication indicating whether the SMF is to be reallocated or the SMF is to be reused is provided to the AMF.

If the control plane CIoT 5GS optimization is enabled for a PDU session and the IP header compression configuration IE was included in the PDU SESSION ESTABLISHMENT REQUEST message or the PDU SESSION MODIFICATION REQUEST message, and the SMF supports control plane CioT 5GS optimization and IP header compression for control plane CioT 5GS optimization, the SMF may include the IP header compression configuration IE in the PDU SESSION MODIFICATION COMMAND message to re-negotiate IP header compression configuration associated to the PDU session.

If the control plane CioT 5GS optimization is enabled for a PDU session and the Ethernet header compression configuration IE was included in the PDU SESSION ESTABLISHMENT REQUEST message or the PDU SESSION MODIFICATION REQUEST message, and the SMF supports control plane CioT 5GS optimization and Ethernet header compression for control plane CioT 5GS optimization, the SMF may include the Ethernet header compression configuration IE in the PDU SESSION MODIFICATION COMMAND message to re-configure Ethernet header compression configuration associated with the PDU session.

If the network-requested PDU session modification procedure is associated with C2 authorization procedure, the SMF shall send the PDU SESSION MODIFICATION COMMAND message by including the Service-level-AA container IE containing:
a) the service-level-AA response with the value of C2AR field set to the “C2 authorization was successful”;
b) if the C2 authorization payload is provided from the UAS-NF, the service-level-AA payload with the value set to the C2 authorization payload and the service-level-AA payload type with the value set to “C2 authorization payload”; and
c) if the CAA-level UAV ID is provided from the UAS-NF, the service-level device ID set to the CAA-level UAV ID.
NOTE 8: The C2 authorization payload in the service-level-AA payload can include one or both of the C2 session security information and C2 pairing information.

If the service-level-AA procedure is triggered for the established PDU session for UAS services with re-authentication purpose, and the SMF is provided by the UAS-NF with the successful UUAA-SM result, the SMF shall transmit a PDU SESSION MODIFICATION COMMAND message to the UE, where the PDU SESSION MODIFICATION COMMAND message shall include the Service-level-AA container IE containing:
a) the service-level-AA response with the value of SLAR field set to “Service level authentication and authorization was successful”;
b) if received the CAA-level UAV ID from the UAS-NF, the service-level device ID with the value set to the CAA-level UAV ID; and
c) if received the UUAA payload from the UAS-NF, the service-level-AA payload with the value set to the UUAA payload.

If the SMF needs to provide new ECS configuration information to the UE and the UE has indicated support for ECS configuration information provisioning in the PDU SESSION ESTABLISHMENT REQUEST message or while in S1 mode, then the SMF may include the Extended protocol configuration options IE in the PDU SESSION MODIFICATION COMMAND message with:
at least one of ECS Ipv4 Address(es), ECS Ipv6 Address(es), ECS FQDN(s);
at least one associated ECSP identifier; and
optionally, spatial validity conditions associated with the ECS address;
NOTE 9: The IP address(es) and/or FQDN(s) are associated with the ECSP identifier and replace previously provided ECS configuration information associated with the same ECSP identifier, if any.

If the SMF needs to provide DNS server address(es) to the UE and the UE has provided the DNS server Ipv4 address request, the DNS server Ipv6 address request or both of them, in the PDU SESSION ESTABLISHMENT REQUEST message or a PDU SESSION MODIFICATION REQUEST message, then the SMF shall include the Extended protocol configuration options IE in the PDU SESSION MODIFICATION COMMAND message with one or more DNS server Ipv4 address(es), one or more DNS server Ipv6 address(es) or both of them.

If the SMF needs to trigger EAS rediscovery and the UE has indicated support of the EAS rediscovery in the PDU SESSION ESTABLISHMENT REQUEST message or the PDU SESSION MODIFICATION REQUEST message, then the SMF shall include the Extended protocol configuration options IE in the PDU SESSION MODIFICATION COMMAND message:
a) with the EAS rediscovery indication without indicated impact; or
b) with the following:
   1) one or more EAS rediscovery indication(s) with impacted EAS Ipv4 address range, if the UE supports EAS rediscovery indication(s) with impacted EAS Ipv4 address range;
   2) one or more EAS rediscovery indication(s) with impacted EAS Ipv6 address range, if the UE supports EAS rediscovery indication(s) with impacted EAS Ipv6 address range;
   3) one or more EAS rediscovery indication(s) with impacted EAS FQDN, if the UE supports EAS rediscovery indication(s) with impacted EAS FQDN; or
   4) any combination of the above.

When UE has requested P-CSCF Ipv6 address or P-CSCF Ipv4 address and the SMF has provided P-CSCF address(es) during the PDU session establishment procedure, if the network-requested PDU session modification procedure is triggered for P-CSCF restoration, the SMF shall include the P-CSCF IP address(es) in the Extended protocol configuration options IE in the PDU SESSION MODIFICATION COMMAND message as specified in subclause 5.8.2.2 of 3GPP TS 23.380 V17.1.0.

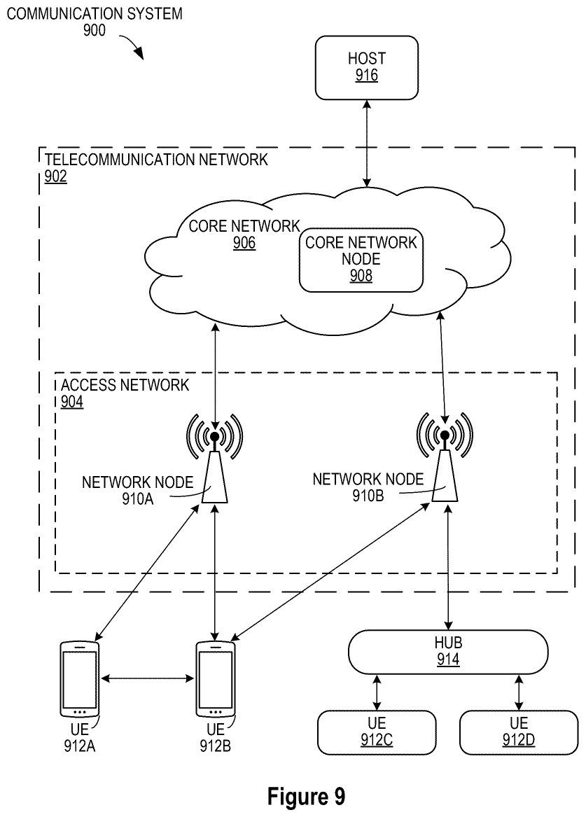

FIG. 9 shows an example of a communication system 900 in accordance with some embodiments. In the example, the communication system 900 includes a telecommunication network 902 that includes an access network 904, such as a radio access network (RAN), and a core network 906, which includes one or more core network nodes 908. For example, embodiments disclosed herein corresponding to actions performed by a network node may be performed by core network node 908. The access network 904 includes one or more access network nodes, such as network nodes 910a and 910b (one or more of which may be generally referred to as network nodes 910 or radio network nodes), or any other similar 3rd Generation Partnership Project (3GPP) access node or non-3GPP access point. The network nodes 910 facilitate direct or indirect connection of user equipment (UE), such as by connecting UEs 912a, 912b, 912c, and 912d (one or more of which may be generally referred to as UEs 912) to the core network 906 over one or more wireless connections. In certain embodiments in accordance with the disclosure the telecommunications network 902 supports interworking between Evolved Packet System (EPS) and Fifth Generation System (5GS) networks, where in certain examples the access network 904 and/or parts of the core network 906 are designated one of EPS and 5GS.

Example wireless communications over a wireless connection include transmitting and/or receiving wireless signals using electromagnetic waves, radio waves, infrared waves, and/or other types of signals suitable for conveying information without the use of wires, cables, or other material conductors. Moreover, in different embodiments, the communication system 900 may include any number of wired or wireless networks, network nodes, UEs, and/or any other components or systems that may facilitate or participate in the communication of data and/or signals whether via wired or wireless connections. The communication system 900 may include and/or interface with any type of communication, telecommunication, data, cellular, radio network, and/or other similar type of system.

The UEs 912 may be any of a wide variety of communication devices, including wireless devices arranged, configured, and/or operable to communicate wirelessly with the network nodes 910 and other communication devices. Similarly, the network nodes 910 are arranged, capable, configured, and/or operable to communicate directly or indirectly with the UEs 912 and/or with other network nodes or equipment in the telecommunication network 902 to enable and/or provide network access, such as wireless network access, and/or to perform other functions, such as administration in the telecommunication network 902.

In the depicted example, the core network 906 connects the network nodes 910 to one or more hosts, such as host 916. These connections may be direct or indirect via one or more intermediary networks or devices. In other examples, network nodes may be directly coupled to hosts. The core network 906 includes one more core network nodes (e.g., core network node 908) that are structured with hardware and software components. Features of these components may be substantially similar to those described with respect to the UEs, network nodes, and/or hosts, such that the descriptions thereof are generally applicable to the corresponding components of the core network node 908. Example core network nodes include functions of one or more of a Mobile Switching Center (MSC), Mobility Management Entity (MME), Home Subscriber Server (HSS), Access and Mobility Management Function (AMF), Session Management Function (SMF), Authentication Server Function (AUSF), Subscription Identifier De-concealing function (SIDF), Unified Data Management (UDM), Security Edge Protection Proxy (SEPP), Network Exposure Function (NEF), and/or a User Plane Function (UPF).

In some examples, the core network node 908 is configured to create a message to modify a packet data unit, PDU, session, the message comprising more than one packet filters to be updated wherein each of the more than one packet filters is associated with a same EPS bearer identity and the message indicates that a wireless device perform more than one traffic flow template operation. For example, the core network node may request the wireless device to perform two or more of the following operations: create new traffic flow template, TFT; delete existing TFT; add packet filters to existing TFT; replace packet filters in existing TFT; delete packet filters from existing TFT. The core network node is further configured to transmit, to a wireless device, the message comprising the updates for the identified EPS bearer and for the more than one packet filters. In further examples the core network node is configured to perform any of the methods or examples embodiments described herein which correspond to a core network node, e.g. an SMF.

The host 916 may be under the ownership or control of a service provider other than an operator or provider of the access network 904 and/or the telecommunication network 902, and may be operated by the service provider or on behalf of the service provider. The host 916 may host a variety of applications to provide one or more service. Examples of such applications include live and pre-recorded audio/video content, data collection services such as retrieving and compiling data on various ambient conditions detected by a plurality of UEs, analytics functionality, social media, functions for controlling or otherwise interacting with remote devices, functions for an alarm and surveillance center, or any other such function performed by a server.

As a whole, the communication system 900 of FIG. 9 enables connectivity between the UEs, network nodes, and hosts. In that sense, the communication system may be configured to operate according to predefined rules or procedures, such as specific standards that include, but are not System for Mobile Communications (GSM); Universal Mobile limited to: Global Telecommunications System (UMTS); Long Term Evolution (LTE), and/or other suitable 2G, 3G, 4G, 5G standards, or any applicable future generation standard (e.g., 6G); wireless local area network (WLAN) standards, such as the Institute of Electrical and Electronics Engineers (IEEE) 802.11 standards (WiFi); and/or any other appropriate wireless communication standard, such as the Worldwide Interoperability for Microwave Access (WiMax), Bluetooth, Z-Wave, Near Field Communication (NFC) ZigBee, LiFi, and/or any low-power wide-area network (LPWAN) standards such as LoRa and Sigfox.

In some examples, the telecommunication network 902 is a cellular network that implements 3GPP standardized features. Accordingly, the telecommunications network 902 may support network slicing to provide different logical networks to different devices that are connected to the telecommunication network 902. For example, the telecommunications network 902 may provide Ultra Reliable Low Latency Communication (URLLC) services to some UEs, while providing Enhanced Mobile Broadband (eMBB) services to other UEs, and/or Massive Machine Type Communication (mMTC)/Massive IoT services to yet further UEs.

In some examples, the UEs 912 are configured to transmit and/or receive information without direct human interaction. For instance, a UE may be designed to transmit information to the access network 904 on a predetermined schedule, when triggered by an internal or external event, or in response to requests from the access network 904. Additionally, a UE may be configured for operating in single- or multi-RAT or multi-standard mode. For example, a UE may operate with any one or combination of Wi-Fi, NR (New Radio) and LTE, i.e. being configured for multi-radio dual connectivity (MR-DC), such as E-UTRAN (Evolved-UMTS Terrestrial Radio Access Network) New Radio-Dual Connectivity (EN-DC).

In the example, the hub 914 communicates with the access network 904 to facilitate indirect communication between one or more UEs (e.g., UE 912c and/or 912d) and network nodes (e.g., network node 910b). In some examples, the hub 914 may be a controller, router, content source and analytics, or any of the other communication devices described herein regarding UEs. For example, the hub 914 may be a broadband router enabling access to the core network 906 for the UEs. As another example, the hub 914 may be a controller that sends commands or instructions to one or more actuators in the UEs. Commands or instructions may be received from the UEs, network nodes 910, or by executable code, script, process, or other instructions in the hub 914. As another example, the hub 914 may be a data collector that acts as temporary storage for UE data and, in some embodiments, may perform analysis or other processing of the data. As another example, the hub 914 may be a content source. For example, for a UE that is a VR headset, display, loudspeaker or other media delivery device, the hub 914 may retrieve VR assets, video, audio, or other media or data related to sensory information via a network node, which the hub 914 then provides to the UE either directly, after performing local processing, and/or after adding additional local content. In still another example, the hub 914 acts as a proxy server or orchestrator for the UEs, in particular in if one or more of the UEs are low energy IoT devices.

The hub 914 may have a constant/persistent or intermittent connection to the network node 910b. The hub 914 may also allow for a different communication scheme and/or schedule between the hub 914 and UEs (e.g., UE 912c and/or 912d), and between the hub 914 and the core network 906. In other examples, the hub 914 is connected to the core network 906 and/or one or more UEs via a wired connection. Moreover, the hub 914 may be configured to connect to an M2M service provider over the access network 904 and/or to another UE over a direct connection. In some scenarios, UEs may establish a wireless connection with the network nodes 910 while still connected via the hub 914 via a wired or wireless connection. In some embodiments, the hub 914 may be a dedicated hub—that is, a hub whose primary function is to route communications to/from the UEs from/to the network node 910b. In other embodiments, the hub 914 may be a non-dedicated hub—that is, a device which is capable of operating to route communications between the UEs and network node 910b, but which is additionally capable of operating as a communication start and/or end point for certain data channels.

FIG. 10 shows a UE 1000 in accordance with some embodiments. As used herein, a UE refers to a device capable, configured, arranged and/or operable to communicate wirelessly with network nodes and/or other UEs. Examples of a UE include, but are not limited to, a smart phone, mobile phone, cell phone, voice over IP (VOIP) phone, wireless local loop phone, desktop computer, personal digital assistant (PDA), wireless cameras, gaming console or device, music storage device, playback appliance, wearable terminal device, wireless endpoint, mobile station, tablet, laptop, laptop-embedded equipment (LEE), laptop-mounted equipment (LME), smart device, wireless customer-premise equipment (CPE), vehicle-mounted or vehicle embedded/integrated wireless device, etc. Other examples include any UE identified by the 3rd Generation Partnership Project (3GPP), including a narrow band internet of things (NB-IoT) UE, a machine type communication (MTC) UE, and/or an enhanced MTC (eMTC) UE.

A UE may support device-to-device (D2D) communication, for example by implementing a 3GPP standard for sidelink communication, Dedicated Short-Range Communication (DSRC), vehicle-to-vehicle (V2V), vehicle-to-infrastructure (V2I), or vehicle-to-everything (V2X). In other examples, a UE may not necessarily have a user in the sense of a human user who owns and/or operates the relevant device. Instead, a UE may represent a device that is intended for sale to, or operation by, a human user but which may not, or which may not initially, be associated with a specific human user (e.g., a smart sprinkler controller). Alternatively, a UE may represent a device that is not intended for sale to, or operation by, an end user but which may be associated with or operated for the benefit of a user (e.g., a smart power meter).

The UE 1000 includes processing circuitry 1002 that is operatively coupled via a bus 1004 to an input/output interface 1006, a power source 1008, a memory 1010, a communication interface 1012, and/or any other component, or any combination thereof. Certain UEs may utilize all or a subset of the components shown in FIG. 10. The level of integration between the components may vary from one UE to another UE. Further, certain UEs may contain multiple instances of a component, such as multiple processors, memories, transceivers, transmitters, receivers, etc.

The processing circuitry 1002 is configured to process instructions and data and may be configured to implement any sequential state machine operative to execute instructions stored as machine-readable computer programs in the memory 1010. The processing circuitry 1002 may be implemented as one or more hardware-implemented state machines (e.g., in discrete logic, field-programmable gate arrays (FPGAs), application specific integrated circuits (ASICs), etc.); programmable logic together with appropriate firmware; one or more stored computer programs, general-purpose processors, such as a microprocessor or digital signal processor (DSP), together with appropriate software; or any combination of the above. For example, the processing circuitry 1002 may include multiple central processing units (CPUs).

In the example, the input/output interface 1006 may be configured to provide an interface or interfaces to an input device, output device, or one or more input and/or output devices. Examples of an output device include a speaker, a sound card, a video card, a display, a monitor, a printer, an actuator, an emitter, a smartcard, another output device, or any combination thereof. An input device may allow a user to capture information into the UE 1000. Examples of an input device include a touch-sensitive or presence-sensitive display, a camera (e.g., a digital camera, a digital video camera, a web camera, etc.), a microphone, a sensor, a mouse, a trackball, a directional pad, a trackpad, a scroll wheel, a smartcard, and the like. The presence-sensitive display may include a capacitive or resistive touch sensor to sense input from a user. A sensor may be, for instance, an accelerometer, a gyroscope, a tilt sensor, a force sensor, a magnetometer, an optical sensor, a proximity sensor, a biometric sensor, etc., or any combination thereof. An output device may use the same type of interface port as an input device. For example, a Universal Serial Bus (USB) port may be used to provide an input device and an output device.

In some embodiments, the power source 1008 is structured as a battery or battery pack. Other types of power sources, such as an external power source (e.g., an electricity outlet), photovoltaic device, or power cell, may be used. The power source 1008 may further include power circuitry for delivering power from the power source 1008 itself, and/or an external power source, to the various parts of the UE 1000 via input circuitry or an interface such as an electrical power cable. Delivering power may be, for example, for charging of the power source 1008. Power circuitry may perform any formatting, converting, or other modification to the power from the power source 1008 to make the power suitable for the respective components of the UE 1000 to which power is supplied.

The memory 1010 may be or be configured to include memory such as random access memory (RAM), read-only memory (ROM), programmable read-only memory (PROM), erasable programmable read-only memory (EPROM), electrically erasable programmable read-only memory (EEPROM), magnetic disks, optical disks, hard disks, removable cartridges, flash drives, and so forth. In one example, the memory 1010 includes one or more application programs 1014, such as an operating system, web browser application, a widget, gadget engine, or other application, and corresponding data 1016. The memory 1010 may store, for use by the UE 1000, any of a variety of various operating systems or combinations of operating systems.

The memory 1010 may be configured to include a number of physical drive units, such as redundant array of independent disks (RAID), flash memory, USB flash drive, external hard disk drive, thumb drive, pen drive, key drive, high-density digital versatile disc (HD-DVD) optical disc drive, internal hard disk drive, Blu-Ray optical disc drive, holographic digital data storage (HDDS) optical disc drive, external mini-dual in-line memory module (DIMM), synchronous dynamic random access memory (SDRAM), external micro-DIMM SDRAM, smartcard memory such as tamper resistant module in the form of a universal integrated circuit card (UICC) including one or more subscriber identity modules (SIMs), such as a USIM and/or ISIM, other memory, or any combination thereof. The UICC may for example be an embedded UICC (eUICC), integrated UICC (iUICC) or a removable UICC commonly known as ‘SIM card.’ The memory 1010 may allow the UE 1000 to access instructions, application programs and the like, stored on transitory or non-transitory memory media, to off-load data, or to upload data. An article of manufacture, such as one utilizing a communication system may be tangibly embodied as or in the memory 1010, which may be or comprise a device-readable storage medium.

The processing circuitry 1002 may be configured to communicate with an access network or other network using the communication interface 1012. The communication interface 1012 may comprise one or more communication subsystems and may include or be communicatively coupled to an antenna 1022. The communication interface 1012 may include one or more transceivers used to communicate, such as by communicating with one or more remote transceivers of another device capable of wireless communication (e.g., another UE or a network node in an access network). Each transceiver may include a transmitter 1018 and/or a receiver 1020 appropriate to provide network communications (e.g., optical, electrical, frequency allocations, and so forth). Moreover, the transmitter 1018 and receiver 1020 may be coupled to one or more antennas (e.g., antenna 1022) and may share circuit components, software or firmware, or alternatively be implemented separately.

In the illustrated embodiment, communication functions of the communication interface 1012 may include cellular communication, Wi-Fi communication, LPWAN communication, data communication, voice communication, multimedia communication, short-range communications such as Bluetooth, near-field communication, location-based communication such as the use of the global positioning system (GPS) to determine a location, another like communication function, or any combination thereof. Communications may be implemented in according to one or more communication protocols and/or standards, such as IEEE 802.11, Code Division Multiplexing Access (CDMA), Wideband Code Division Multiple Access (WCDMA), GSM, LTE, New Radio (NR), UMTS, WiMax, Ethernet, transmission control protocol/internet protocol (TCP/IP), synchronous optical networking (SONET), Asynchronous Transfer Mode (ATM), QUIC, Hypertext Transfer Protocol (HTTP), and so forth.

Regardless of the type of sensor, a UE may provide an output of data captured by its sensors, through its communication interface 1012, via a wireless connection to a network node. Data captured by sensors of a UE can be communicated through a wireless connection to a network node via another UE. The output may be periodic (e.g., once every 15 minutes if it reports the sensed temperature), random (e.g., to even out the load from reporting from several sensors), in response to a triggering event (e.g., when moisture is detected an alert is sent), in response to a request (e.g., a user initiated request), or a continuous stream (e.g., a live video feed of a patient).

As another example, a UE comprises an actuator, a motor, or a switch, related to a communication interface configured to receive wireless input from a network node via a wireless connection. In response to the received wireless input the states of the actuator, the motor, or the switch may change. For example, the UE may comprise a motor that adjusts the control surfaces or rotors of a drone in flight according to the received input or to a robotic arm performing a medical procedure according to the received input.

A UE, when in the form of an Internet of Things (IoT) device, may be a device for use in one or more application domains, these domains comprising, but not limited to, city wearable technology, extended industrial application and healthcare. Non-limiting examples of such an IoT device are a device which is or which is embedded in: a connected refrigerator or freezer, a TV, a connected lighting device, an electricity meter, a robot vacuum cleaner, a voice controlled smart speaker, a home security camera, a motion detector, a thermostat, a smoke detector, a door/window sensor, a flood/moisture sensor, an electrical door lock, a connected doorbell, an air conditioning system like a heat pump, an autonomous vehicle, a surveillance system, a weather monitoring device, a vehicle parking monitoring device, an electric vehicle charging station, a smart watch, a fitness tracker, a head-mounted display for Augmented Reality (AR) or Virtual Reality (VR), a wearable for tactile augmentation or sensory enhancement, a water sprinkler, an animal- or item-tracking device, a sensor for monitoring a plant or animal, an industrial robot, an Unmanned Aerial Vehicle (UAV), and any kind of medical device, like a heart rate monitor or a remote controlled surgical robot. A UE in the form of an IoT device comprises circuitry and/or software in dependence of the intended application of the IoT device in addition to other components as described in relation to the UE 1000 shown in FIG. 10.

As yet another specific example, in an IoT scenario, a UE may represent a machine or other device that performs monitoring and/or measurements, and transmits the results of such monitoring and/or measurements to another UE and/or a network node. The UE may in this case be an M2M device, which may in a 3GPP context be referred to as an MTC device. As one particular example, the UE may implement the 3GPP NB-IoT standard. In other scenarios, a UE may represent a vehicle, such as a car, a bus, a truck, a ship and an airplane, or other equipment that is capable of monitoring and/or reporting on its operational status or other functions associated with its operation.

In practice, any number of UEs may be used together with respect to a single use case. For example, a first UE might be or be integrated in a drone and provide the drone's speed information (obtained through a speed sensor) to a second UE that is a remote controller operating the drone. When the user makes changes from the remote controller, the first UE may adjust the throttle on the drone (e.g. by controlling an actuator) to increase or decrease the drone's speed. The first and/or the second UE can also include more than one of the functionalities described above. For example, a UE might comprise the sensor and the actuator, and handle communication of data for both the speed sensor and the actuators.

In some embodiments the wireless device or UE 1000 is configured to receive a message to modify a packet data unit, PDU, session, the message comprising more than one packet filters to be updated wherein each of the more than one packet filters is associated with a same EPS bearer identity. The message indicates that the wireless device or UE 1000 is to perform more than one traffic flow template operation. For example the wireless device or UE 1000 is requested to perform two or more of the following operations: create new traffic flow template, TFT; delete existing TFT; add packet filters to existing TFT; replace packet filters in existing TFT; delete packet filters from existing TFT. The wireless device or UE 1000 is further configured to perform the updates for the identified EPS bearer and for the more than one packet filters. The wireless device or UE 1000 is further configured to perform any of the methods or example embodiments corresponding to a wireless device disclosed herein.

FIG. 11 shows a network node or radio access network node 1100 in accordance with some embodiments.

As used herein, network node refers to equipment capable, configured, arranged and/or operable to communicate directly or indirectly with a UE and/or with other network nodes or equipment, in a telecommunication network. Examples of network nodes include, but are not limited to, access points (APs) (e.g., radio access points), base stations (BSs) (e.g., radio base stations, Node Bs, evolved Node Bs (eNBs) and NR NodeBs (gNBs)).

Base stations may be categorized based on the amount of coverage they provide (or, stated differently, their transmit power level) and so, depending on the provided amount of coverage, may be referred to as femto base stations, pico base stations, micro base stations, or macro base stations. A base station may be a relay node or a relay donor node controlling a relay. A network node may also include one or more (or all) parts of a distributed radio base station such as centralized digital units and/or remote radio units (RRUs), sometimes referred to as Remote Radio Heads (RRHs). Such remote radio units may or may not be integrated with an antenna as an antenna integrated radio. Parts of a distributed radio base station may also be referred to as nodes in a distributed antenna system (DAS).

Other examples of network nodes include multiple transmission point (multi-TRP) 5G access nodes, multi-standard radio (MSR) equipment such as MSR BSs, network controllers such as radio network controllers (RNCs) or base station controllers (BSCs), base transceiver stations (BTSs), transmission points, transmission nodes, multi-cell/multicast coordination entities (MCEs), Operation and Maintenance (O&M) nodes, Operations Support System (OSS) nodes, Self-Organizing Network (SON) nodes, positioning nodes (e.g., Evolved Serving Mobile Location Centers (E-SMLCs)), and/or Minimization of Drive Tests (MDTs).

The network node 1100 includes a processing circuitry 1102, a memory 1104, a communication interface 1106, and a power source 1108. The network node 1100 may be composed of multiple physically separate components (e.g., a NodeB component and a RNC component, or a BTS component and a BSC component, etc.), which may each have their own respective components. In certain scenarios in which the network node 1100 comprises multiple separate components (e.g., BTS and BSC components), one or more of the separate components may be shared among several network nodes. For example, a single RNC may control multiple NodeBs. In such a scenario, each unique NodeB and RNC pair, may in some instances be considered a single separate network node.

In some embodiments, the network node 1100 may be configured to support multiple radio access technologies (RATs). In such embodiments, some components may be duplicated (e.g., separate memory 1104 for different RATs) and some components may be reused (e.g., a same antenna 1110 may be shared by different RATs). The network node 1100 may also include multiple sets of the various illustrated components for different wireless technologies integrated into network node 1100, for example GSM, WCDMA, LTE, NR, WiFi, Zigbee, Z-wave, LoRaWAN, Radio Frequency Identification (RFID) or Bluetooth wireless technologies. These wireless technologies may be integrated into the same or different chip or set of chips and other components within network node 1100.

The processing circuitry 1102 may comprise a combination of one or more of a microprocessor, controller, microcontroller, central processing unit, digital signal processor, application-specific integrated circuit, field programmable gate array, or any other suitable computing device, resource, or combination of hardware, software and/or encoded logic operable to provide, either alone or in conjunction with other network node 1100 components, such as the memory 1104, to provide network node 1100 functionality.

In some embodiments, the processing circuitry 1102 includes a system on a chip (SOC). In some embodiments, the processing circuitry 1102 includes one or more of radio frequency (RF) transceiver circuitry 1112 and baseband processing circuitry 1114. In some embodiments, the radio frequency (RF) transceiver circuitry 1112 and the baseband processing circuitry 1114 may be on separate chips (or sets of chips), boards, or units, such as radio units and digital units. In alternative embodiments, part or all of RF transceiver circuitry 1112 and baseband processing circuitry 1114 may be on the same chip or set of chips, boards, or units.

The memory 1104 may comprise any form of volatile or non-volatile computer-readable memory including, without limitation, persistent storage, solid-state memory, remotely mounted memory, magnetic media, optical media, random access memory (RAM), read-only memory (ROM), mass storage media (for example, a hard disk), removable storage media (for example, a flash drive, a Compact Disk (CD) or a Digital Video Disk (DVD)), and/or any other volatile or non-volatile, non-transitory device-readable and/or computer-executable memory devices that store information, data, and/or instructions that may be used by the processing circuitry 1102. The memory 1104 may store any suitable instructions, data, or information, including a computer program, software, an application including one or more of logic, rules, code, tables, and/or other instructions capable of being executed by the processing circuitry 1102 and utilized by the network node 1100. The memory 1104 may be used to store any calculations made by the processing circuitry 1102 and/or any data received via the communication interface 1106. In some embodiments, the processing circuitry 1102 and memory 1104 is integrated.

The communication interface 1106 is used in wired or wireless communication of signaling and/or data between a network node, access network, and/or UE. As illustrated, the communication interface 1106 comprises port(s)/terminal(s) 1116 to send and receive data, for example to and from a network over a wired connection. The communication interface 1106 also includes radio front-end circuitry 1118 that may be coupled to, or in certain embodiments a part of, the antenna 1110. Radio front-end circuitry 1118 comprises filters 1120 and amplifiers 1122. The radio front-end circuitry 1118 may be connected to an antenna 1110 and processing circuitry 1102. The radio front-end circuitry may be configured to condition signals communicated between antenna 1110 and processing circuitry 1102. The radio front-end circuitry 1118 may receive digital data that is to be sent out to other network nodes or UEs via a wireless connection. The radio front-end circuitry 1118 may convert the digital data into a radio signal having the appropriate channel and bandwidth parameters using a combination of filters 1120 and/or amplifiers 1122. The radio signal may then be transmitted via the antenna 1110. Similarly, when receiving data, the antenna 1110 may collect radio signals which are then converted into digital data by the radio front-end circuitry 1118. The digital data may be passed to the processing circuitry 1102. In other embodiments, the communication interface may comprise different components and/or different combinations of components.

In certain alternative embodiments, the network node 1100 does not include separate radio front-end circuitry 1118, instead, the processing circuitry 1102 includes radio front-end circuitry and is connected to the antenna 1110. Similarly, in some embodiments, all or some of the RF transceiver circuitry 1112 is part of the communication interface 1106. In still other embodiments, the communication interface 1106 includes one or more ports or terminals 1116, the radio front-end circuitry 1118, and the RF transceiver circuitry 1112, as part of a radio unit (not shown), and the communication interface 1106 communicates with the baseband processing circuitry 1114, which is part of a digital unit (not shown).

The antenna 1110 may include one or more antennas, or antenna arrays, configured to send and/or receive wireless signals. The antenna 1110 may be coupled to the radio front-end circuitry 1118 and may be any type of antenna capable of transmitting and receiving data and/or signals wirelessly. In certain embodiments, the antenna 1110 is separate from the network node 1100 and connectable to the network node 1100 through an interface or port.

The antenna 1110, communication interface 1106, and/or the processing circuitry 1102 may be configured to perform any receiving operations and/or certain obtaining operations described herein as being performed by the network node. Any information, data and/or signals may be received from a UE, another network node and/or any other network equipment. Similarly, the antenna 1110, the communication interface 1106, and/or the processing circuitry 1102 may be configured to perform any transmitting operations described herein as being performed by the network node. Any information, data and/or signals may be transmitted to a UE, another network node and/or any other network equipment.

The power source 1108 provides power to the various components of network node 1100 in a form suitable for the respective components (e.g., at a voltage and current level needed for each respective component). The power source 1108 may further comprise, or be coupled to, power management circuitry to supply the components of the network node 1100 with power for performing the functionality described herein. For example, the network node 1100 may be connectable to an external power source (e.g., the power grid, an electricity outlet) via an input circuitry or interface such as an electrical cable, whereby the external power source supplies power to power circuitry of the power source 1108. As a further example, the power source 1108 may comprise a source of power in the form of a battery or battery pack which is connected to, or integrated in, power circuitry. The battery may provide backup power should the external power source fail.

Embodiments of the network node 1100 may include additional components beyond those shown in FIG. 11 for providing certain aspects of the network node's functionality, including any of the functionality described herein and/or any functionality necessary to support the subject matter described herein. For example, the network node 1100 may include user interface equipment to allow input of information into the network node 1100 and to allow output of information from the network node 1100. This may allow a user to perform diagnostic, maintenance, repair, and other administrative functions for the network node 1100.

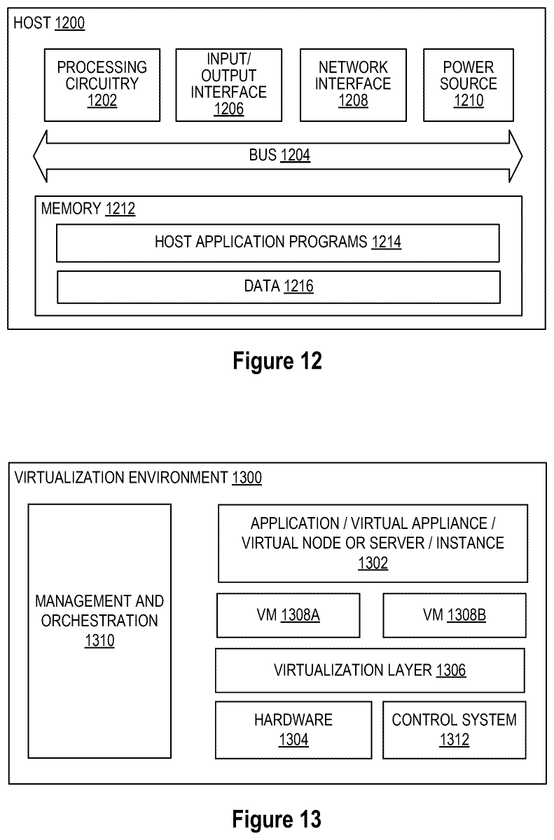

FIG. 12 is a block diagram of a host 1200, which may be an embodiment of the host 916 of FIG. 9, in accordance with various aspects described herein. As used herein, the host 1200 may be or comprise various combinations hardware and/or software, including a standalone server, a blade server, a cloud-implemented server, a distributed server, a virtual machine, container, or processing resources in a server farm. The host 1200 may provide one or more services to one or more UEs.

The host 1200 includes processing circuitry 1202 that is operatively coupled via a bus 1204 to an input/output interface 1206, a network interface 1208, a power source 1210, and a memory 1212. Other components may be included in other embodiments. Features of these components may be substantially similar to those described with respect to the devices of previous figures, such as FIGS. 10 and 11, such that the descriptions thereof are generally applicable to the corresponding components of host 1200.

The memory 1212 may include one or more computer programs including one or more host application programs 1214 and data 1216, which may include user data, e.g., data generated by a UE for the host 1200 or data generated by the host 1200 for a UE. Embodiments of the host 1200 may utilize only a subset or all of the components shown. The host application programs 1214 may be implemented in a container-based architecture and may provide support for video codecs (e.g., Versatile Video Coding (VVC), High Efficiency Video Coding (HEVC), Advanced Video Coding (AVC), MPEG, VP9) and audio codecs (e.g., FLAC, Advanced Audio Coding (AAC), MPEG, G.711), including transcoding for multiple different classes, types, or implementations of UEs (e.g., handsets, desktop computers, wearable display systems, heads-up display systems). The host application programs 1214 may also provide for user authentication and licensing checks and may periodically report health, routes, and content availability to a central node, such as a device in or on the edge of a core network. Accordingly, the host 1200 may select and/or indicate a different host for over-the-top services for a UE. The host application programs 1214 may support various protocols, such as the HTTP Live Streaming (HLS) protocol, Real-Time Messaging Protocol (RTMP), Real-Time Streaming Protocol (RTSP), Dynamic Adaptive Streaming over HTTP (MPEG-DASH), etc.

FIG. 13 is a block diagram illustrating a virtualization environment 1300 in which functions implemented by some embodiments may be virtualized.

In the present context, virtualizing means creating virtual versions of apparatuses or devices which may include virtualizing hardware platforms, storage devices and networking resources. As used herein, virtualization can be applied to any device described herein, or components thereof, and relates to an implementation in which at least a portion of the functionality is implemented as one or more virtual components. Some or all of the functions described herein may be implemented as virtual components executed by one or more virtual machines (VMs) implemented in one or more virtual environments 1300 hosted by one or more of hardware nodes, such as a hardware computing device that operates as a network node, UE, core network node, or host. Further, in embodiments in which the virtual node does not require radio connectivity (e.g., a core network node or host), then the node may be entirely virtualized.

Applications 1302 (which may alternatively be called software instances, virtual appliances, network functions, virtual nodes, virtual network functions, etc.) are run in the virtualization environment Q400 to implement some of the features, functions, and/or benefits of some of the embodiments disclosed herein.

Hardware 1304 includes processing circuitry, memory that stores software and/or instructions executable by hardware processing circuitry, and/or other hardware devices as described herein, such as a network interface, input/output interface, and so forth. Software may be executed by the processing circuitry to instantiate one or more virtualization layers 1306 (also referred to as hypervisors or virtual machine monitors (VMMs)), provide VMs 1308a and 1308b (one or more of which may be generally referred to as VMs 1308), and/or perform any of the functions, features and/or benefits described in relation with some embodiments described herein. The virtualization layer 1306 may present a virtual operating platform that appears like networking hardware to the VMs 1308.

The VMs 1308 comprise virtual processing, virtual memory, virtual networking or interface and virtual storage, and may be run by a corresponding virtualization layer 1306. Different embodiments of the instance of a virtual appliance 1302 may be implemented on one or more of VMs 1308, and the implementations may be made in different ways. Virtualization of the hardware is in some contexts referred to as network function virtualization (NFV). NFV may be used to consolidate many network equipment types onto industry standard high volume server hardware, physical switches, and physical storage, which can be located in data centers, and customer premise equipment.

In the context of NFV, a VM 1308 may be a software implementation of a physical machine that runs programs as if they were executing on a physical, non-virtualized machine. Each of the VMs 1308, and that part of hardware 1304 that executes that VM, be it hardware dedicated to that VM and/or hardware shared by that VM with others of the VMs, forms separate virtual network elements. Still in the context of NFV, a virtual network function is responsible for handling specific network functions that run in one or more VMs 1308 on top of the hardware 1304 and corresponds to the application 1302.

Hardware 1304 may be implemented in a standalone network node with generic or specific components. Hardware 1304 may implement some functions via virtualization. Alternatively, hardware 1304 may be part of a larger cluster of hardware (e.g. such as in a data center or CPE) where many hardware nodes work together and are managed via management and orchestration 1310, which, among others, oversees lifecycle management of applications 1302. In some embodiments, hardware 1304 is coupled to one or more radio units that each include one or more transmitters and one or more receivers that may be coupled to one or more antennas. Radio units may communicate directly with other hardware nodes via one or more appropriate network interfaces and may be used in combination with the virtual components to provide a virtual node with radio capabilities, such as a radio access node or a base station. In some embodiments, some signaling can be provided with the use of a control system 1312 which may alternatively be used for communication between hardware nodes and radio units.

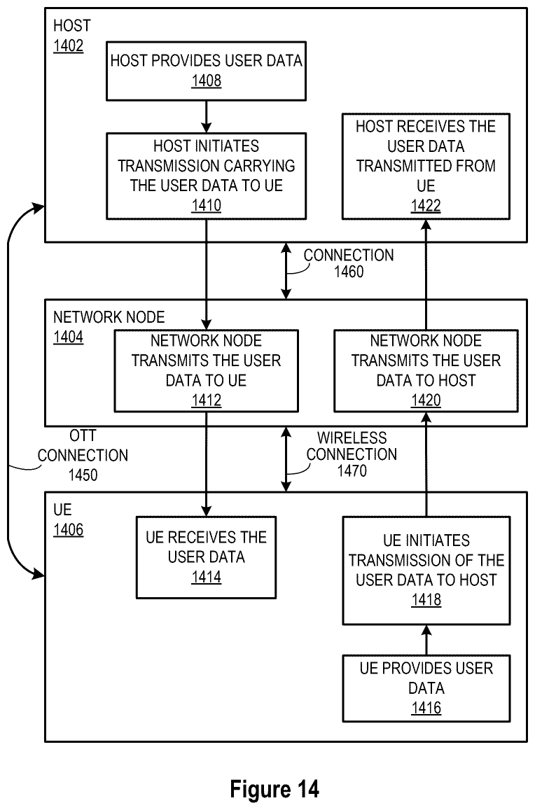

FIG. 14 shows a communication diagram of a host 1402 communicating via a network node 1404 with a UE 1406 over a partially wireless connection in accordance with some embodiments. Example implementations, in accordance with various embodiments, of the UE (such as a UE 912a of FIG. 9 and/or UE 1000 of FIG. 10), network node (such as network node 910a of FIG. 9 and/or network node 1100 of FIG. 11), and host (such as host 916 of FIG. 9 and/or host 1200 of FIG. 12) discussed in the preceding paragraphs will now be described with reference to FIG. 14.

Like host 1200, embodiments of host 1402 include hardware, such as a communication interface, processing circuitry, and memory. The host 1402 also includes software, which is stored in or accessible by the host 1402 and executable by the processing circuitry. The software includes a host application that may be operable to provide a service to a remote user, such as the UE 1406 connecting via an over-the-top (OTT) connection 1450 extending between the UE 1406 and host 1402. In providing the service to the remote user, a host application may provide user data which is transmitted using the OTT connection 1450.

The network node 1404 includes hardware enabling it to communicate with the host 1402 and UE 1406. The connection 1460 may be direct or pass through a core network (like core network 906 of FIG. 9) and/or one or more other intermediate networks, such as one or more public, private, or hosted networks. For example, an intermediate network may be a backbone network or the Internet.

The UE 1406 includes hardware and software, which is stored in or accessible by UE 1406 and executable by the UE's processing circuitry. The software includes a client application, such as a web browser or operator-specific “app” that may be operable to provide a service to a human or non-human user via UE 1406 with the support of the host 1402. In the host 1402, an executing host application may communicate with the executing client application via the OTT connection 1450 terminating at the UE 1406 and host 1402. In providing the service to the user, the UE's client application may receive request data from the host's host application and provide user data in response to the request data. The OTT connection 1450 may transfer both the request data and the user data. The UE's client application may interact with the user to generate the user data that it provides to the host application through the OTT connection 1450.

The OTT connection 1450 may extend via a connection 1460 between the host 1402 and the network node 1404 and via a wireless connection 1470 between the network node 1404 and the UE 1406 to provide the connection between the host 1402 and the UE 1406. The connection 1460 and wireless connection 1470, over which the OTT connection 1450 may be provided, have been drawn abstractly to illustrate the communication between the host 1402 and the UE 1406 via the network node 1404, without explicit reference to any intermediary devices and the precise routing of messages via these devices.

As an example of transmitting data via the OTT connection 1450, in step 1408, the host 1402 provides user data, which may be performed by executing a host application. In some embodiments, the user data is associated with a particular human user interacting with the UE 1406. In other embodiments, the user data is associated with a UE 1406 that shares data with the host 1402 without explicit human interaction. In step 1410, the host 1402 initiates a transmission carrying the user data towards the UE 1406. The host 1402 may initiate the transmission responsive to a request transmitted by the UE 1406. The request may be caused by human interaction with the UE 1406 or by operation of the client application executing on the UE 1406. The transmission may pass via the network node 1404, in accordance with the teachings of the embodiments described throughout this disclosure. Accordingly, in step 1412, the network node 1404 transmits to the UE 1406 the user data that was carried in the transmission that the host 1402 initiated, in accordance with the teachings of the embodiments described throughout this disclosure. In step 1414, the UE 1406 receives the user data carried in the transmission, which may be performed by a client application executed on the UE 1406 associated with the host application executed by the host 1402.

In some examples, the UE 1406 executes a client application which provides user data to the host 1402. The user data may be provided in reaction or response to the data received from the host 1402. Accordingly, in step 1416, the UE 1406 may provide user data, which may be performed by executing the client application. In providing the user data, the client application may further consider user input received from the user via an input/output interface of the UE 1406. Regardless of the specific manner in which the user data was provided, the UE 1406 initiates, in step 1418, transmission of the user data towards the host 1402 via the network node 1404. In step 1420, in accordance with the teachings of the embodiments described throughout this disclosure, the network node 1404 receives user data from the UE 1406 and initiates transmission of the received user data towards the host 1402. In step 1422, the host 1402 receives the user data carried in the transmission initiated by the UE 1406.

In an example scenario, factory status information may be collected and analyzed by the host 1402. As another example, the host 1402 may process audio and video data which may have been retrieved from a UE for use in creating maps. As another example, the host 1402 may collect and analyze real-time data to assist in controlling vehicle congestion (e.g., controlling traffic lights). As another example, the host 1402 may store surveillance video uploaded by a UE. As another example, the host 1402 may store or control access to media content such as video, audio, VR or AR which it can broadcast, multicast or unicast to UEs. As other examples, the host 1402 may be used for energy pricing, remote control of non-time critical electrical load to balance power generation needs, location services, presentation services (such as compiling diagrams etc. from data collected from remote devices), or any other function of collecting, retrieving, storing, analyzing and/or transmitting data.

In some examples, a measurement procedure may be provided for the purpose of monitoring data rate, latency and other factors on which the one or more embodiments improve. There may further be an optional network functionality for reconfiguring the OTT connection 1450 between the host 1402 and UE 1406, in response to variations in the measurement results. The measurement procedure and/or the network functionality for reconfiguring the OTT connection may be implemented in software and hardware of the host 1402 and/or UE 1406. In some embodiments, sensors (not shown) may be deployed in or in association with other devices through which the OTT connection 1450 passes; the sensors may participate in the measurement procedure by supplying values of the monitored quantities exemplified above, or supplying values of other physical quantities from which software may compute or estimate the monitored quantities. The reconfiguring of the OTT connection 1450 may include message format, retransmission settings, preferred routing etc.; the reconfiguring need not directly alter the operation of the network node 1404. Such procedures and functionalities may be known and practiced in the art. In certain embodiments, measurements may involve proprietary UE signaling that facilitates measurements of throughput, propagation times, latency and the like, by the host 1402. The measurements may be implemented in that software causes messages to be transmitted, in particular empty or ‘dummy’ messages, using the OTT connection 1450 while monitoring propagation times, errors, etc.

Although the computing devices described herein (e.g., UEs, network nodes, hosts) may include the illustrated combination of hardware components, other embodiments may comprise computing devices with different combinations of components. It is to be understood that these computing devices may comprise any suitable combination of hardware and/or software needed to perform the tasks, features, functions and methods disclosed herein. Determining, calculating, obtaining or similar operations described herein may be performed by processing circuitry, which may process information by, for example, converting the obtained information into other information, comparing the obtained information or converted information to information stored in the network node, and/or performing one or more operations based on the obtained information or converted information, and as a result of said processing making a determination. Moreover, while components are depicted as single boxes located within a larger box, or nested within multiple boxes, in practice, computing devices may comprise multiple different physical components that make up a single illustrated component, and functionality may be partitioned between separate components. For example, a communication interface may be configured to include any of the components described herein, and/or the functionality of the components may be partitioned between the processing circuitry and the communication interface. In another example, non-computationally intensive functions of any of such components may be implemented in software or firmware and computationally intensive functions may be implemented in hardware.

In certain embodiments, some or all of the functionality described herein may be provided by processing circuitry executing instructions stored on in memory, which in certain embodiments may be a computer program product in the form of a non-transitory computer-readable storage medium. In alternative embodiments, some or all of the functionality may be provided by the processing circuitry without executing instructions stored on a separate or discrete device-readable storage medium, such as in a hard-wired manner. In any of those particular embodiments, whether executing instructions stored on a non-transitory computer-readable storage medium or not, the processing circuitry can be configured to perform the described functionality. The benefits provided by such functionality are not limited to the processing circuitry alone or to other components of the computing device, but are enjoyed by the computing device as a whole, and/or by end users and a wireless network generally.

### Example Embodiments

Example 1. A method performed by a wireless device for updating packet filters when interworking between Evolved Packet System (EPS) and Fifth Generation System (5GS) networks, the method comprising: receiving an EPS bearer context from a network node, the EPS bearer context comprising updates for more than one packet filter; and performing the updates for the more than one packet filter.

Example 2. The method of Example 1, wherein the wireless device receives more than one EPS bearer context with a same bearer identifier and each EPS bearer context comprises a packet filter update.

Example 3. The method of Example 1, wherein the wireless device receives an EPS bearer context with an operation code that indicates to replace all packet filters with the packet filters in the EPS bearer context.

Example 4. The method Example 1, wherein the wireless device receives an EPS bearer context that includes more than one traffic flow template (TFT).

Example 5. The method of Example 1, wherein the wireless device receives an EPS bearer context according to any one or more of alternatives 1, 2 and 3 described above.

Example 6. A method performed by a wireless device, the method comprising: any of the wireless device steps, features, or functions described above, either alone or in combination with other steps, features, or functions described above.

Example 7. The method of the previous Example, further comprising one or more additional wireless device steps, features or functions described above.

Example 8. The method of any of the previous Examples, further comprising: providing user data; and forwarding the user data to a host computer via the transmission to the base station.

Example 9. A method performed by a base station for updating packet filters when interworking between Evolved Packet System (EPS) and Fifth Generation System (5GS) networks, the method comprising: receiving an EPS bearer context from another network node, the EPS bearer context comprising updates for more than one packet filter; and transmitting the EPS bearer context to a wireless device.

Example 10. The method of Example 9, wherein the network node receives more than one EPS bearer context with a same bearer identifier and each EPS bearer context comprises a packet filter update.

Example 11. The method of Example 9, wherein the network node receives an EPS bearer context with an operation code that indicates to replace all packet filters with the packet filters in the EPS bearer context.

Example 12. The method Example 9, wherein the network node receives an EPS bearer context that includes more than one traffic flow template (TFT).

Example 13. The method of Example 9, wherein the network node receives an EPS bearer context according to any one or more of alternatives 1, 2 and 3 described above.

Example 14. A method performed by a base station, the method comprising: any of the steps, features, or functions described above with respect to base station, either alone or in combination with other steps, features, or functions described above.

Example 15. The method of the previous Example, further comprising one or more additional base station steps, features or functions described above.

Example 16. The method of any of the previous Examples, further comprising: obtaining user data; and forwarding the user data to a host computer or a wireless device.

Example 17. A mobile terminal comprising: processing circuitry configured to perform any of the steps of any of Examples 1-8; and power supply circuitry configured to supply power to the wireless device.

Example 18. A base station comprising: processing circuitry configured to perform any of the steps of any of Examples 9-16; power supply circuitry configured to supply power to the wireless device.

Example 19. A user equipment (UE) comprising: an antenna configured to send and receive wireless signals; radio front-end circuitry connected to the antenna and to processing circuitry, and configured to condition signals communicated between the antenna and the processing circuitry; the processing circuitry being configured to perform any of the steps of any of Examples 1-8; and an input interface connected to the processing circuitry and configured to allow input of information into the UE to be processed by the processing circuitry; an output interface connected to the processing circuitry and configured to output information from the UE that has been processed by the processing circuitry; and a battery connected to the processing circuitry and configured to supply power to the UE.

Example 20. A communication system including a host computer comprising: processing circuitry configured to provide user data; and a communication interface configured to forward the user data to a cellular network for transmission to a user equipment (UE), wherein the cellular network comprises a base station having a radio interface and processing circuitry, the base station's processing circuitry configured to perform any of the steps of any of Examples 9-16.

Example 21. The communication system of the previous Example further including the base station.

Example 22. The communication system of the previous 2 Examples, further including the UE, wherein the UE is configured to communicate with the base station.

Example 23. The communication system of the previous 3 Examples, wherein: the processing circuitry of the host computer is configured to execute a host application, thereby providing the user data; and the UE comprises processing circuitry configured to execute a client application associated with the host application.

Example 24. A method implemented in a communication system including a host computer, a base station and a user equipment (UE), the method comprising: at the host computer, providing user data; and at the host computer, initiating a transmission carrying the user data to the UE via a cellular network comprising the base station, wherein the base station performs any of the steps of any of Examples 9-16.

Example 25. The method of the previous Example, further comprising, at the base station, transmitting the user data.

Example 26. The method of the previous 2 Examples, wherein the user data is provided at the host computer by executing a host application, the method further comprising, at the UE, executing a client application associated with the host application.

Example 27. A user equipment (UE) configured to communicate with a base station, the UE comprising a radio interface and processing circuitry configured to performs any of the previous 3 Examples.

Example 28. A communication system including a host computer comprising: processing circuitry configured to provide user data; and a communication interface configured to forward user data to a cellular network for transmission to a user equipment (UE), wherein the UE comprises a radio interface and processing circuitry, the UE's components configured to perform any of the steps of any of Examples 1-8.

Example 29. The communication system of the previous Example, wherein the cellular network further includes a base station configured to communicate with the UE.

Example 30. The communication system of the previous 2 Examples, wherein: the processing circuitry of the host computer is configured to execute a host application, thereby providing the user data; and the UE's processing circuitry is configured to execute a client application associated with the host application.

Example 31. A method implemented in a communication system including a host computer, a base station and a user equipment (UE), the method comprising: at the host computer, providing user data; and at the host computer, initiating a transmission carrying the user data to the UE via a cellular network comprising the base station, wherein the UE performs any of the steps of any of Examples 1-8.

Example 32. The method of the previous Example, further comprising at the UE, receiving the user data from the base station.

Example 33. A communication system including a host computer comprising: communication interface configured to receive user data originating from a transmission from a user equipment (UE) to a base station, wherein the UE comprises a radio interface and processing circuitry, the UE's processing circuitry configured to perform any of the steps of any of Examples 1-8.

Example 34. The communication system of the previous Example, further including the UE.

Example 35. The communication system of the previous 2 Examples, further including the base station, wherein the base station comprises a radio interface configured to communicate with the UE and a communication interface configured to forward to the host computer the user data carried by a transmission from the UE to the base station.

Example 36. The communication system of the previous 3 Examples, wherein: the processing circuitry of the host computer is configured to execute a host application; and the UE's processing circuitry is configured to execute a client application associated with the host application, thereby providing the user data.

Example 37. The communication system of the previous 4 Examples, wherein: the processing circuitry of the host computer is configured to execute a host application, thereby providing request data; and the UE's processing circuitry is configured to execute a client application associated with the host application, thereby providing the user data in response to the request data.

Example 38. A method implemented in a communication system including a host computer, a base station and a user equipment (UE), the method comprising: at the host computer, receiving user data transmitted to the base station from the UE, wherein the UE performs any of the steps of any of Examples 1-8.

Example 39. The method of the previous Example, further comprising, at the UE, providing the user data to the base station.

Example 40. The method of the previous 2 Examples, further comprising: at the UE, executing a client application, thereby providing the user data to be transmitted; and at the host computer, executing a host application associated with the client application.

Example 41. The method of the previous 3 Examples, further comprising: at the UE, executing a client application; and at the UE, receiving input data to the client application, the input data being provided at the host computer by executing a host application associated with the client application, wherein the user data to be transmitted is provided by the client application in response to the input data.

Example 42. A communication system including a host computer comprising a communication interface configured to receive user data originating from a transmission from a user equipment (UE) to a base station, wherein the base station comprises a radio interface and processing circuitry, the base station's processing circuitry configured to perform any of the steps of any of Examples 9-16.

Example 43. The communication system of the previous Example further including the base station.

Example 44. The communication system of the previous 2 Examples, further including the UE, wherein the UE is configured to communicate with the base station.

Example 45. The communication system of the previous 3 Examples, wherein: the processing circuitry of the host computer is configured to execute a host application; the UE is configured to execute a client application associated with the host application, thereby providing the user data to be received by the host computer.

Example 46. A method implemented in a communication system including a host computer, a base station and a user equipment (UE), the method comprising: at the host computer, receiving, from the base station, user data originating from a transmission which the base station has received from the UE, wherein the UE performs any of the steps of any of Examples 1-8.

Example 47. The method of the previous Example, further comprising at the base station, receiving the user data from the UE.

Example 48. The method of the previous 2 Examples, further comprising at the base station, initiating a transmission of the received user data to the host computer.

1.-29. (canceled)

30. A method performed by a wireless device for updating packet filters supporting interworking between Evolved Packet System (EPS) and Fifth Generation System (5GS) networks, the method comprising:
receiving a message to update packet filters associated with a PDU session established over 5GS, the message comprising multiple mapped EPS bearer context fields with the same EPS bearer identity associated to a quality of service (QoS) flow of the PDU session and each of the multiple mapped EPS bearer context fields comprises a traffic flow template (TFT) comprising a TFT operation code and at least one identifier associated to one of the packet filters to be updated, wherein each TFT operation code indicates one of the following operations:
create new TFT;
delete existing TFT;
add packet filters to existing TFT;
replace packet filters in existing TFT;
delete packet filters from existing TFT; and
updating the packet filters for the identified EPS bearer in the multiple EPS bearer context fields according to the multiple TFT operation codes wherein the multiple TFT operation codes are required for updating the packet filters.

31. The method of claim 30, wherein at least two of the EPS bearer context fields are associated with the same TFT.

32. The method of claim 30, wherein updating the packet filters further comprises updating the packet filters according to the TFT operation code to add packet filters to existing TFT and at least one of the TFT operation code to replace packet filters in existing TFT or to delete packet filters from existing TFT.

33. The method of claim 30 wherein an EPS bearer context field comprises more than one EPS parameter wherein each EPS parameter comprises a TFT which include a TFT operation code for updating one or more packet filters.

34. The method of claim 30, wherein when a TFT operation code indicates to the wireless device to replace
all packet filters in an existing TFT, the TFT in the EPS parameter lists all packet filters to be included for the EPS bearer and which replaces any previously defined packet filters for the EPS bearer.

35. The method of claim 34, wherein the TFT operation code is defined using reserved bit value ‘111’.

36. The method of claim 30 wherein the message comprises at least one operation
code associated with the EPS bearer identity indicating one of:
create a new EPS bearer;
delete an existing EPS bearer; and
modify an existing EPS bearer.

37. The method of claim 36, wherein the message is a PDU session modification message.

38. The method of claim 30, wherein the multiple EPS bearer context fields with the same EPS bearer identity for updating the packet filters in a TFT are used when a number of packet filters to be updated exceeds the length of a single EPS bearer context field and/or TFT field of the TFT.

39. A method performed by a network node for updating packet filters when
interworking between Evolved Packet System, EPS, and Fifth Generation System, SGS, networks is supported, the method comprising:
creating a message to modify a packet data unit, PDU, session, the message comprising multiple mapped EPS bearer context fields with the same EPS bearer identity associated to a quality of service (QoS) flow of the PDU session and each of the multiple mapped EPS bearer context fields comprises a traffic flow template (TFT) comprising a TFT operation code and at least one identifier associated to one of the packet filters to be updated, wherein each TFT operation code indicates one of the following operations:
create new TFT;
delete existing TFT;
add packet filters to existing TFT;
replace packet filters in existing TFT; and
delete packet filters from existing TFT; and,
transmitting, to the wireless device, the message comprising a request to perform updates for the identified EPS bearer based on the multiple mapped EPS bearer context fields associated with the EPS bearer identity.

40. The method of claim 39, wherein at least two of the EPS bearer context fields are associated with the same TFT.

41. The method of claim 39, wherein updating the packet filters further comprises updating the packet filters according to the TFT operation code to add packet filters to existing TFT and at least one of the TFT operation code to replace packet filters in existing TFT or to delete packet filters from existing TFT.

42. The method of claim 39, wherein an EPS bearer context field comprises more than one EPS parameter wherein each EPS parameter comprises a TFT which include a TFT operation code for updating one or more packet filters.

43. The method of claim 39, wherein when a TFT operation code indicates to the wireless device to replace all packet filters in an existing TFT, the TFT in the EPS parameter lists all packet filters to be included for the EPS bearer and which replaces any previously defined packet filters for the EPS bearer.

44. The method of claim 43, wherein the TFT operation code is defined using reserved bit value ‘111’.

45. The method of claim 39, wherein the message comprises at least one operation
code associated with the EPS bearer identity indicating one of:
create a new EPS bearer;
delete an existing EPS bearer; and
modify an existing EPS bearer.

46. The method of claim 39, wherein the message is a PDU session modification message.

47. The method of claim 39, wherein the multiple EPS bearer context fields with the same EPS bearer identity for updating the packet filters in a TFT are used when a number of packet filters to be updated exceeds the length of a single EPS bearer context field and/or TFT field of the TFT.

48. A wireless device for updating packet filters supporting interworking between Evolved Packet System (EPS) and Fifth Generation System (5GS) networks, the wireless device comprising processing circuitry operable to:
receive a message to update packet filters associated with a PDU session established over 5GS, the message comprising multiple mapped EPS bearer context fields with the same EPS bearer identity associated to a quality of service (QoS) flow of the PDU session and each of the multiple mapped EPS bearer context fields comprises a traffic flow template (TFT) comprising a TFT operation code and at least one identifier associated to one of the packet filters to be updated, wherein each TFT operation code indicates one of the following operations:
create new TFT;
delete existing TFT;
add packet filters to existing TFT;
replace packet filters in existing TFT;
delete packet filters from existing TFT; and
update the packet filters for the identified EPS bearer in the multiple EPS bearer context fields according to the multiple TFT operation codes wherein the multiple TFT operation codes are required for updating the packet filters.

49. A network node for updating packet filters when interworking between Evolved Packet System, EPS, and Fifth Generation System, SGS, networks is supported, the network node comprising processing circuitry operable to:
create a message to modify a packet data unit, PDU, session, the message comprising multiple mapped EPS bearer context fields with the same EPS bearer identity associated to a quality of service (QoS) flow of the PDU session and each of the multiple mapped EPS bearer context fields comprises a traffic flow template (TFT) comprising a TFT operation code and at least one identifier associated to one of the packet filters to be updated, wherein each TFT operation code indicates one of the following operations:
create new TFT;
delete existing TFT;
add packet filters to existing TFT;
replace packet filters in existing TFT; and
delete packet filters from existing TFT; and,
transmit, to the wireless device, the message comprising a request to perform updates for the identified EPS bearer based on the multiple mapped EPS bearer context fields associated with the EPS bearer identity.
